(19) United States
(12) Patent Application Publication
(10) Pub. No.: US 2026/0147257 A1
(43) Pub. Date: May 28, 2026

(54) IMAGING LENS ASSEMBLY, CAMERA MODULE, AND IMAGING DEVICE

(71) Applicant: GUANGDONG OPPO MOBILE TELECOMMUNICATIONS CORP., LTD., Dongguan (CN)

(72) Inventor: Daigo KATSURAGI, Nishi-ku (JP)

(21) Appl. No.: 19/450,317

(22) Filed: Jan. 15, 2026

Related U.S. Application Data
(63) Continuation of application No. PCT/CN2023/119853, filed on Sep. 19, 2023.

(51) Int. Cl. G03B 17/17; G02B 13/00; G02B 27/64

(52) U.S. Cl. CPC G03B 17/17; G02B 13/0065; G02B 27/646

(57) ABSTRACT

An imaging lens assembly includes: a prism that bends a light incident from an object side and emits the light to an image side; and at least one lens disposed on the image side of the prism. The imaging lens assembly is configured so that: 5.0≤Σd/Yh≤12.0, where Σd is a distance on an optical axis from an optical surface closest to an object to an imaging surface, and Yh is an image height.

### CROSS-REFERENCE TO RELATED APPLICATIONS

The present application is a continuation of International Patent Application No. PCT/CN2023/119853, filed Sep. 19, 2023, the entire disclosure of which is incorporated herein by reference.

### TECHNICAL FIELD

The present disclosure relates to an imaging lens assembly, a camera module, and an imaging device, and specifically relates to the imaging lens assembly, the camera module, and the imaging device that are small and enable favorable optical performance.

### BACKGROUND

In recent years, portable imaging devices such as mobile phones or digital cameras are being widely used. As recent imaging devices are miniaturized, imaging lens assemblies mounted on the imaging devices are also required to be small. To fulfill such miniaturization requirements, a conventional imaging lens assembly used to secure a focal length of the imaging lens assembly within limited space by disposing a prism, which captures light from the object side, on an object side of a lens group. Such imaging lens assembly is called as a periscope-type imaging lens assembly.

However, the prism in the conventional periscope-type imaging lens assembly was formed of heavy glass.

Accordingly, it was difficult to make the conventional imaging lens assembly small and light.

### SUMMARY

The present disclosure provides an imaging lens assembly, a camera module, and an imaging device.

In accordance with a first aspect of the present disclosure, the imaging lens assembly includes: a prism that bends a light incident from an object side and emits the light to an image side; and at least one lens disposed on the image side of the prism. The imaging lens assembly is configured such that: 5.0≤Σd/Yh≤12.0, where Σd is a distance on an optical axis from an optical surface closest to an object to an imaging surface, and Yh is an image height.

In accordance with a second aspect of the present disclosure, the camera module includes an imaging lens assembly and an image sensor having an imaging surface. The imaging lens assembly includes: a prism that bends a light incident from an object side and emits the light to an image side; and at least one lens disposed on the image side of the prism. The imaging lens assembly is configured such that: 5.0≤Σd/Yh≤12.0, where Σd is a distance on an optical axis from an optical surface closest to an object to an imaging surface, and Yh is an image height.

In accordance with a third aspect of the present disclosure, the imaging device includes a camera module and a housing that stores the camera module. The camera module includes an imaging lens assembly and an image sensor having an imaging surface. The imaging lens assembly includes: a prism that bends a light incident from an object side and emits the light to an image side; and at least one lens disposed on the image side of the prism. The imaging lens assembly is configured such that: 5.0≤Σd/Yh≤12.0, where Σd is a distance on an optical axis from an optical surface closest to an object to an imaging surface, and Yh is an image height.

### BRIEF DESCRIPTION OF THE DRAWINGS

These and/or other aspects and advantages of embodiments of the present disclosure will become apparent and more readily appreciated from the following descriptions made with reference to the drawing.

FIG. 1 is a diagram illustrating an example of a camera module according to the present disclosure.

FIG. 2 is a diagram illustrating an example of an imaging device according to the present disclosure.

FIG. 3A is a diagram illustrating a first modification of a prism according to the present disclosure.

FIG. 3B is a diagram illustrating a second modification of the prism according to the present disclosure.

FIG. 3C is a diagram illustrating a third modification of the prism according to the present disclosure.

FIG. 3D is a diagram illustrating a fourth modification of the prism according to the present disclosure.

FIG. 4 is a diagram illustrating an imaging lens assembly before and after an optical image stabilization (OIS) according to the present disclosure.

FIG. 5 is a diagram illustrating the imaging lens assembly in a zooming state to a WIDE and a TELE side according to the present disclosure.

FIG. 6A is a configuration diagram of the camera module in the zooming state to the WIDE side according to a first example of the present disclosure.

FIG. 6B is a configuration diagram of the camera module in the zooming state to the TELE side according to the first example of the present disclosure.

FIG. 7A is an aberration diagram of the camera module in the zooming state to the WIDE side according to the first example of the present disclosure.

FIG. 7B is an aberration diagram of the camera module in the zooming state to the TELE side according to the first example of the present disclosure.

FIG. 8 is a configuration diagram of the camera module according to a second example of the present disclosure.

FIG. 9 is an aberration diagram of the camera module according to the second example of the present disclosure.

FIG. 10 is a configuration diagram of the camera module according to a third example of the present disclosure.

FIG. 11 is an aberration diagram of the camera module according to the third example of the present disclosure.

FIG. 12 is a configuration diagram of the camera module according to a fourth example of the present disclosure.

FIG. 13 is an aberration diagram of the camera module according to the fourth example of the present disclosure.

FIG. 14 is a configuration diagram of the camera module according to a fifth example of the present disclosure.

FIG. 15 is an aberration diagram of the camera module according to the fifth example of the present disclosure.

### DETAILED DESCRIPTION

Embodiments of the present disclosure will be described in detail and examples of the embodiments will be shown in the accompanying drawings. Same or similar elements and elements having same or similar functions are denoted by like reference numerals throughout the descriptions. The embodiments described herein with reference to the drawings are explanatory, which aim to illustrate the present disclosure, but shall not be construed to limit the present disclosure.

### OUTLINE OF THE PRESENT DISCLOSURE

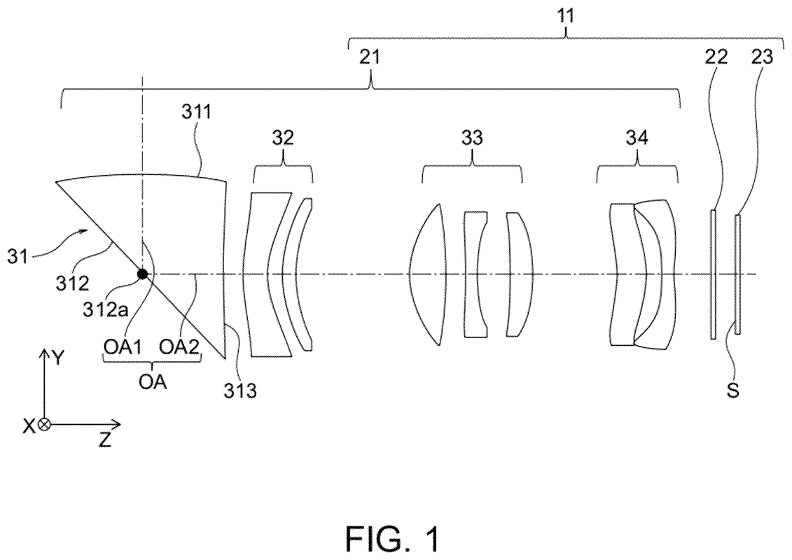

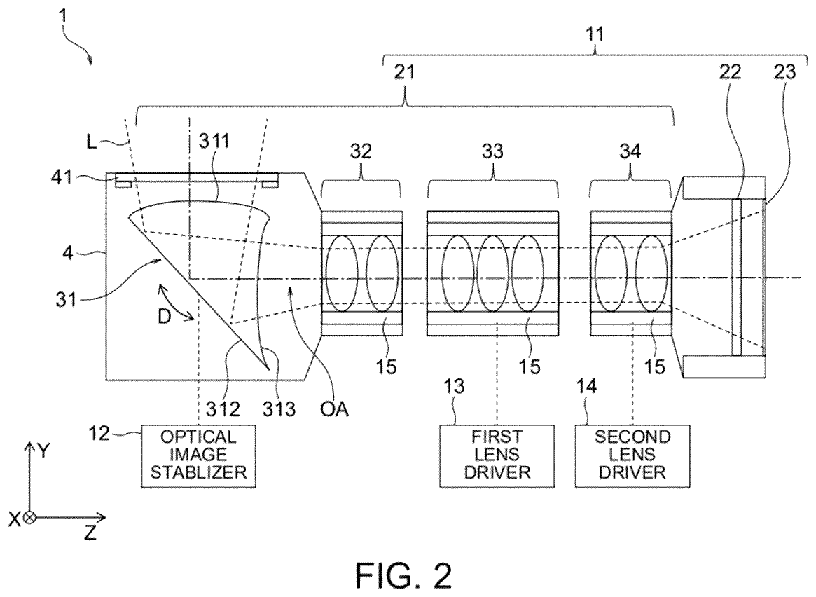

First, an outline of the present disclosure will be described. As shown in FIG. 1, a camera module 11 applied with the present disclosure includes an imaging lens assembly 21, an optical filter 22, and an image sensor 23 having an imaging surface S. As shown in FIG. 2, the camera module 11 is stored in a housing 4 to configure the imaging device 1.

Note that, in FIG. 1, a dash-dot line represents an optical axis OA of the imaging lens assembly 21 (hereinafter the same applies). In the description below, a direction along an optical axis OA2, which is included in the optical axis OA and is located on a reflecting side of a prism 31 described later, is denoted as a Z-axis direction. Also, a direction of thickness (i.e., direction of height) of the imaging device 1 is denoted as a Y-axis direction, and a direction orthogonal to the Z-axis and the Y-axis direction as an X-axis direction.

As shown in FIG. 1, the imaging lens assembly 21 includes a prism 31, a first lens group 32, a second lens group 33, and a third lens group 34 in order from an object side.

The prism 31 bends a light (denoted as L in FIG. 2), which is incident from the object side via a cover glass 41 provided in the housing 4, and reflects the light to an image side. The prism 31 is formed of resin material. The resin material may be, for example, plastic. Since the prism 31 is formed of resin material, the prism 31 may be lighter than when the prism 31 is formed of glass. For example, a weight of the prism 31 may be reduced to about ⅓ than when formed of glass.

The prism 31 includes an incident surface 311, a reflective surface 312, and an emitting surface 313. Light is incident on the incident surface 311 from the object side. The reflective surface 312 reflects the light, which is incident on the incident surface 311, to the image side. The emitting surface 313 emits the light, which is reflected by the reflective surface 312, to the image side.

As shown in FIG. 1, the incident surface 311 may be a curved surface. Specifically, as shown in FIG. 1, the incident surface 311 may be a convex surface facing the object side. The incident surface 311 may be either a spherical or an aspherical convex surface facing the object side. If the incident surface 311 is a curved surface, the prism 31 may function as a lens, and thus it is possible to increase a numerical aperture NA of the imaging lens assembly 21 with a small structure. If the prism 31 is formed of resin material, the incident surface 311 may be easily formed as the curved surface.

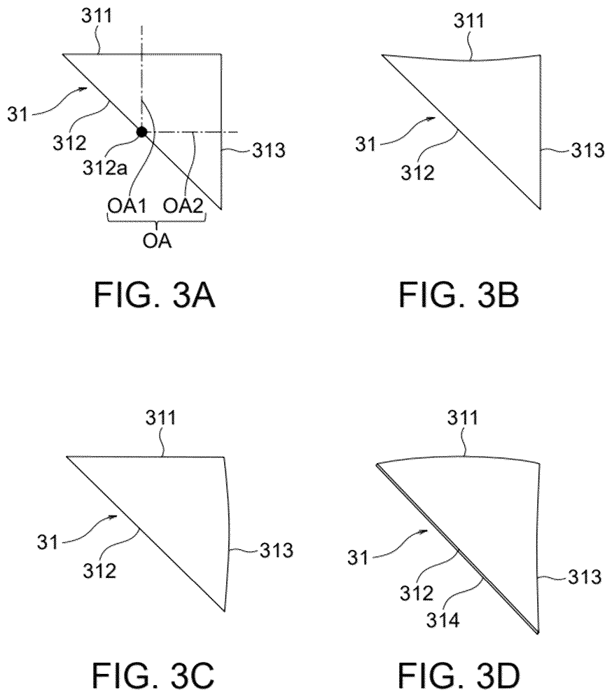

The shape of the incident surface 311 is not limited to the shape shown in FIG. 1. For instance, as shown in FIG. 3A, the incident surface 311 may be a flat surface orthogonal to the optical axis OA. Also, as shown in FIG. 3B, the incident surface 311 may be a concave surface facing the object side. The incident surface 311 may be either a spherical or an aspherical concave surface facing the object side. In this way, the shape of the incident surface 311 may be modified in various ways to increase a degree of freedom in optical design.

As shown in FIG. 1, the reflective surface 312 is disposed to be inclined with respect to the optical axis OA. Specifically, the reflective surface 312 is inclined with respect to the optical axis OA1, which is located on the incident side of the reflective surface 312, and the optical axis OA2 which is located on the reflecting side of the reflective surface 312. The optical axis OA1 on the incident side and the optical axis OA2 on the reflecting side are connected together at an intersection 312a on the reflective surface 312 to form the optical axis OA. The reflective surface 312, for example, may be disposed at an angle of 45° with respect to the optical axis OA1 on the incident side and the optical axis OA2 on the reflecting side. In other words, the reflective surface 312 may be disposed to bend the optical axis OA by 90°.

The reflective surface 312 may reflect the light incident from the incident surface 311 with total reflection. Otherwise, as shown in FIG. 3D, the prism 31 may reflect the incident light by a reflective film 314 disposed on the reflective surface 312. The reflective film 314 may be formed by coating metal material on the reflective surface 312.

The emitting surface 313 may be a curved surface. Specifically, as shown in FIG. 1, the emitting surface 313 may be a concave surface facing the image side. The emitting surface 313 may be either a spherical or an aspherical concave surface facing the image side. If the emitting surface 313 is a curved surface, the prism 31 may function as a lens, and thus it is possible to increase the numerical aperture NA of the imaging lens assembly 21 with a small structure. If the prism 31 is formed of resin material, the emitting surface 313 may be easily formed as the curved surface.

The shape of the emitting surface 313 is not limited to the shape shown in FIG. 1. For example, as shown in FIG. 3A, the emitting surface 313 may be a flat surface orthogonal to the optical axis OA. Alternatively, as shown in FIG. 3C, the emitting surface 313 may be a convex surface facing the image side. The emitting surface 313 may be either a spherical or an aspherical convex surface facing the image side. In this way, the shape of the emitting surface 313 may be modified in various ways to increase the degree of freedom in the optical design.

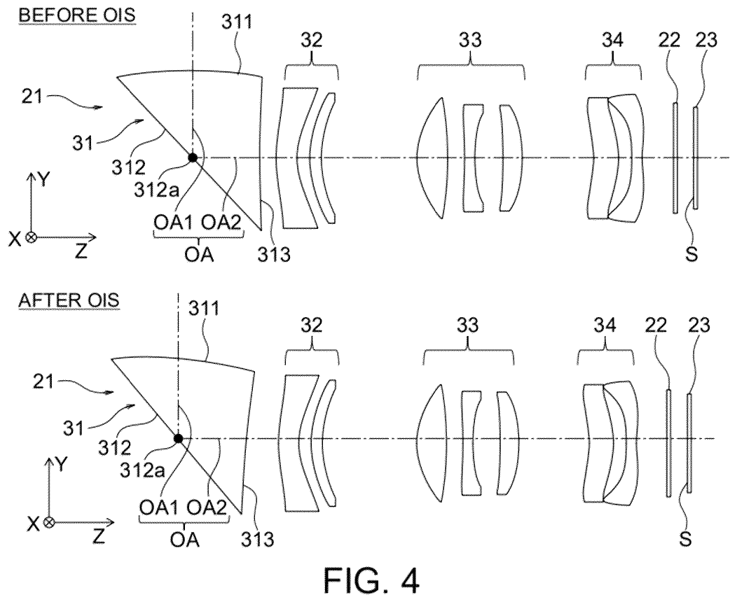

As shown in FIG. 2, the prism 31 includes an optical image stabilizer 12. The optical image stabilizer 12 reduces image disturbances due to camera shake by performing camera shake correction through rotating the prism 31 in a direction that cancels the camera shake. The optical image stabilizer 12, for example, includes a drive source such as a motor and a driving force transmission member such as a gear that transmits the driving force of the drive source to the prism 31. More specifically, the prism 31 is configured to be rotatable by the optical image stabilizer 12 in a direction D that changes the angle of the reflective surface 312 to the optical axis OA (i.e., reflective direction of the light reflected by the reflective surface 312). As an example, FIG. 4 shows the imaging lens assembly 21 before and after correcting the camera shake with the optical image stabilizer 12.

Since the prism 31 is formed of a lightweight resin material, the optical image stabilizer 12 that drives the prism 31 may be configured in a small size. Also, by providing the optical image stabilizer 12 on the prism 31, a thickness of the imaging device 1 (i.e., size in the Y-axis direction) may be reduced than when forming the optical image stabilizer 12 on the image sensor 23.

The first lens group 32 includes at least one lens having a positive or negative refractive power. The first lens group 32 emits light incident from the prism 31 side towards the second lens group 33 side. The first lens group 32 is fixed at a predetermined position inside the housing 4.

The second lens group 33 includes at least one lens having positive or negative refractive power. The second lens group 33 emits light incident from the first lens group 32 side to the third lens group 34 side. As shown in FIG. 2, a first lens driver 13 is provided on the second lens group 33. The first lens driver 13, for example, includes a drive source such as a motor and a driving force transmission member such as a gear that transmits the driving force of the drive source to the second lens group 33. The second lens group 33 is configured to be movable in the optical axis OA direction by the first lens driver 13. A focus operation of the second lens group 33 may be performed by moving the second lens group 33 in the optical axis OA direction with the first lens driver 13.

The third lens group 34 includes at least one lens having positive or negative refractive power. The third lens group 34 emits light incident from the second lens group 33 side to the optical filter 22 side. As shown in FIG. 2, a second lens driver 14 is provided on the third lens group 34. The second lens driver 14, for example, includes a drive source such as a motor and a driving force transmission member such as a gear that transmits the driving force of the drive source to the third lens group 34. The third lens group 34 is configured to be movable in the optical axis OA direction by the second lens driver 14. A focus operation of the third lens group 34 may be performed by moving the third lens group 34 in the optical axis OA direction with the second lens driver 14.

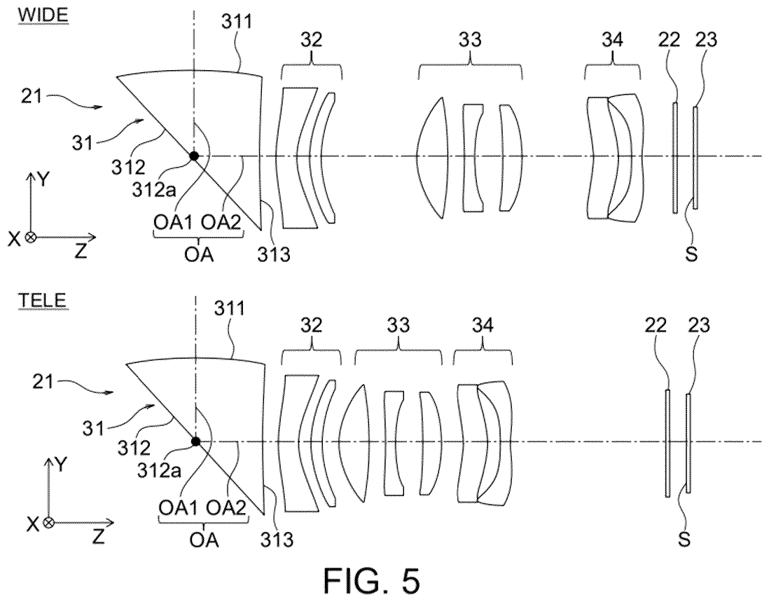

As an example, FIG. 5 shows the imaging lens assembly 21 in a zooming state to a wide-angle (WIDE) side where the second lens group 33 and the third lens group 34 are moved to the image side. FIG. 5 also shows the imaging lens assembly 21 in the zooming state to a telephoto (TELE) side where the second lens group 33 and the third lens group 34 are moved to the object side.

As shown in FIG. 2, the first lens group 32, the second lens group 33, and the third lens group 34 are stored in a barrel 15 inside the housing 4.

The image sensor 23 may consist of a solid-state image sensor such as a Complementary Metal Oxide Semiconductor (CMOS) or a Charge Coupled Device (CCD) and includes the imaging surface S (i.e., an imaging plane) of the imaging lens assembly 21. The image sensor 23 receives light incident from a subject (object side) via the imaging lens assembly 21 and the optical filter 22, photoelectrically converts the light, and outputs a resulting imaging data for a subsequent stage. The optical filter 22, disposed between the imaging lens assembly 21 and the image sensor 23, may be an IR (infrared) filter which cuts infrared light from incident light, for example.

According to the abovementioned imaging lens assembly 21 including the prism 31 formed of resin material, the imaging lens assembly 21 may be lightened by saving the weight of the prism 31. Also, the degree of freedom in designing the prism 31, the numerical aperture NA, and the optical performance of the prism 31 may be enhanced by forming the incident surface 311 and the emitting surface 313 of the prism as the curved surface. Further, when the optical image stabilizer 12 is provided on the prism 31, the optical image stabilizer 12 may be configured small, and the thickness and weight of the imaging device 1 may be reduced compared to when the optical image stabilizer 12 is provided on the image sensor 23. Accordingly, by providing the optical image stabilizer 12 on the prism 31, the optical performance of the imaging device 1 may be enhanced while making the imaging device 1 small and light.

Also, since the second lens group 33 and the third lens group 34 are movable in the optical axis OA direction, a degree of freedom in selecting the focal length may be enhanced while maintaining a small configuration.

An image side surface of the lens closest to the image among the third lens group 34 may have an aspheric shape with an inflection point. By such, a back focus may be effectively reduced. Especially, if the lens closest to the image among the third lens group 34 has the negative refractive power near the optical axis OA, the back focus may be more suitably reduced. For example, the image side surface of the lens closest to the image among the third lens group 34 may have a concave shape near the optical axis OA and a convex shape in the periphery.

Further, the camera module 11 may further effectively lighten the imaging lens assembly 21 by satisfying the following inequality (1).

$$- 1. < ( ( PNd - 1.75 ) * PNd * 100 ) / PVd \leq - 0.56 \qquad ( 1 )$$

In inequality (1), PNd is a refractive index of the prism 31 (hereinafter the same applies). PVd is an Abbe number of the prism 31 (hereinafter the same applies).

It becomes difficult to form the prism 31 with resin material lightly when the value of ((PNd−1.75)*PNd*100)/PVd goes outside the range shown in inequality (1).

Further, the camera module may more effectively miniaturize the imaging lens assembly 21 while maintaining favorable optical performance by satisfying the following inequality (2).

$$5. \leq Σ d / Yh \leq 12. \qquad ( 2 )$$

In inequality (2), Σd is a distance on the optical axis OA from the optical surface closest to the object to the imaging surface S (hereinafter the same applies). In the example of FIGS. 1 and 2, the optical surface closest to the object side is the incident surface 311 of the prism 31 (i.e., a first surface of the prism 31). Yh is an image height of the imaging lens assembly 21.

It becomes difficult to miniaturize the imaging lens assembly 21 when the value of Σd/Yh goes outside the range shown in inequality (2).

Further, the camera module 11 may more effectively miniaturize the imaging lens assembly 21 while maintaining favorable optical performance by satisfying the following inequality (3).

$$Σ d / f \leq 4. \qquad ( 3 )$$

In inequality (3), f is a focal length of the imaging lens assembly 21 (hereinafter the same applies).

It becomes difficult to miniaturize the imaging lens assembly 21 when the value of Σd/f exceeds the upper limit shown in inequality (3).

Further, the camera module 11 may allow the prism 31 to totally reflect the incident light appropriately by satisfying the following inequality (4).

$$( 45 - ( ( 180 / π ) * ( {sin}^{- 1} ( ( sin ( π / 180 ) * θ ) / PNd ) ) / ( {sin}^{- 1} ( 1 / PNd ) * ( 180 / π ) \geq 1 \qquad ( 4 )$$

In inequality (4), θ is a half angle of view of the imaging lens assembly 21 (hereinafter the same applies).

If the value of the left side of inequality (4) falls below 1, it becomes difficult for the prism 31 to totally reflect the incident light since the half angle of view increases and the refractive index of the prism 31 decreases.

On the other hand, even when the prism 31 is formed of resin material with a low refractive index, the camera module 11 may allow the prism 31 to appropriately reflect the incident light using the reflective film 314 by satisfying the following inequality (5).

$$( 45 - ( ( 180 / π ) * ( {sin}^{- 1} ( ( sin ( π / 180 ) * θ ) / PNd ) ) / ( {sin}^{- 1} ( 1 / PNd ) * ( 180 / π ) < 1 \qquad ( 5 )$$

Further, the camera module 11 may more effectively maintain favorable optical performance by satisfying the following inequality (6).

$$Pd / Yh > 1.3 \qquad ( 6 )$$

In inequality (6), Pd is a distance on the optical axis OA from the incident surface 311 of the prism 31 (i.e., surface on the object side) to the emitting surface 313 of the prism 31 (i.e., surface on the image side) (hereinafter the same applies). In other words, Pd is a thickness of the prism 31 in a direction along the optical axis OA.

It becomes difficult to suitably design the optics in response to the size of the image sensor 23 when the value of Pd/Yh falls below the lower limit of inequality (6).

From a perspective of forming the lens, the aspheric lens among the lenses that form the imaging lens assembly 21, especially the aspheric lens with the inflection point is preferably formed of plastic material. Also, among the lenses that form the imaging lens assembly 21, lenses that are smaller than a predetermined size may be formed of plastic material, and lenses larger than the predetermined size may be formed of glass material. This is because it is difficult to form the aspheric lens or the relatively small lens using material other than plastic.

Such a camera module 11 including the imaging lens assembly 21 may be used in compact digital devices (imaging devices) such as mobile phones, wearable cameras and surveillance cameras.

Next, more specific examples to which the present disclosure applies will be described. In the following examples, “Si” indicates a number of an i-th surface that sequentially increases from the object side toward the imaging surface S side. Optical elements of the corresponding surfaces are indicated by the corresponding surface number “Si”. Denotations of “first surface” or “1st surface” indicate a surface on the object side of the lens or prism, and denotations of “second surface” or “2nd surface” indicate a surface on the imaging surface S side of the lens or the prism. “Ri” indicates the value of a central curvature radius (mm) of the i-th surface. “Di” indicates a value of a distance on the optical axis OA between the i-th surface and the (i+1)-th surface (mm). “Ndi” indicates a value of a refractive index at d-line (wavelength 587.6 nm) of the material of the optical element having the i-th surface. “vdi” indicates a value of the Abbe number at d-line of the material of the optical element having the i-th surface.

The imaging lens assembly 21 used in the following examples includes lenses and prisms having aspheric surfaces. The aspheric shape of the lens and prism is defined by the following equation (7).

$$Z = C \times {h}^{2} / \{ 1 + {( 1 - K \times {C}^{2} \times {h}^{2} )}^{1 / 2} \} + Σ An \times {h}^{n} \qquad ( 7 )$$

(n=an integer greater than or equal to 3)

In the equation (7), Z is a depth of the aspheric surface. C is a paraxial curvature which is equal to 1/R. h is a distance from the optical axis to a lens surface. K is a conic constant (second-order aspheric coefficient). An is an nth-order aspheric coefficient.

### First Example

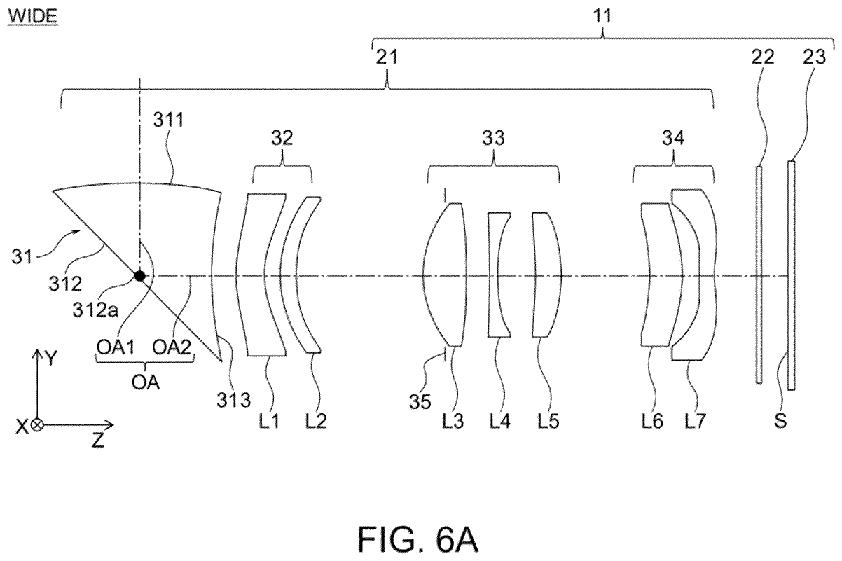

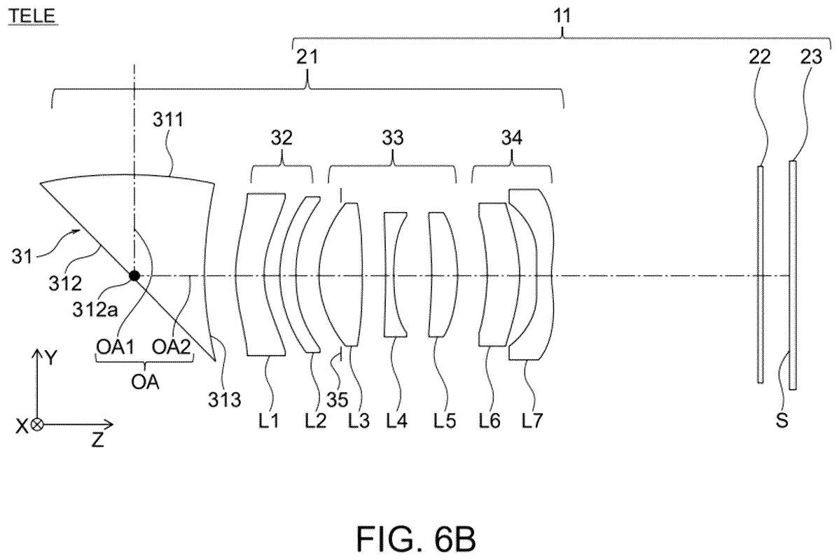

To begin, a first example, in which specific numerical values are applied to the camera module 11 shown in FIGS. 6A and 6B, will be described.

In the first example, the imaging lens assembly 21 includes, in order from the object side toward the image side, the prism 31, the first lens group 32, the second lens group 33, and the third lens group 34. The prism 31 includes the incident surface 311 (i.e., first surface) convex to the object side, the reflective surface 312, and the emitting surface 313 (i.e., second surface) concave to the image side. The reflective surface 312 may be either a total reflective surface or a reflective surface where the reflective film 314 (see FIG. 3D) is formed on. The first lens group 32 includes, in order from the object side toward the image side, a first lens L1 having negative refractive power and a second lens L2 having negative refractive power. The second lens group 33 includes, in order from the object side toward the image side, a third lens L3 having positive refractive power and a convex surface facing the object side, a fourth lens L4 having negative refractive power, and a fifth lens L5 having a positive refractive power and a convex surface facing the image side. The third lens group 34 includes, in order from the object side to the image side, a sixth lens L6 having positive refractive power and a seventh lens L7 having negative refractive power. The shape of the second surface of the seventh lens L7 is concave near the optical axis and convex in the periphery. An aperture stop 35 is disposed on the third lens L3.

Table 1 shows lens data of the first example. Note that the unit of lengths and distances of the imaging lens assembly 21 shown in the tables below is in mm. Table 2 shows values of the focal length of each lens (L1-L7). Table 2 further shows values of composite focal lengths of the first lens group LG1 (including the first lens L1 and the second lens L2), the second lens group LG2 (including the third to fifth lens L3-L5), and the third lens group LG3 (including the sixth lens L6 and the seven lens L7). Table 3 shows the focal length f of the imaging lens assembly 21, an F-number Fno, an angle of view 2ω, the distance Σd on the optical axis OA from the optical surface closest to the object to the imaging surface S, a length Σd1 of the first lens group 32 on the optical axis OA, a length Σd2 of the second lens group 33 on the optical axis OA, a length Σd3 of the third lens group 34 on the optical axis OA, the distance between surfaces (D6, D13, D17) on the optical axis OA, and the image height Yh. These parameters are described in Table 3 for each of the imaging lens assembly 21 in the zooming state to the WIDE side (FIG. 6A) and TELE side (FIG. 6B). Table 4 shows values of inequalities. Table 5 shows the aspherical coefficients of the imaging lens assembly 21.

TABLE 1

| Si | Ri | Di | Ndi | v d i |
|---|---|---|---|---|
| 1(1ST SURFACE OF PRISM) | 20.244 | 8.100 | 1.5445 | 56.33 |
| 2(2ND SURFACE OF PRISM) | 17.556 | 1.000 | | |
| 3(1ST SURFACE OF L1) | 6.763 | 1.322 | 1.5445 | 56.33 |
| 4(2ND SURFACE OF L1) | 4.566 | 0.730 | | |
| 5(1ST SURFACE OF L2) | 6.047 | 0.714 | 1.6707 | 19.23 |
| 6(2ND SURFACE OF L2) | 5.726 | 6.834 | | |
| 7(APERTURE STOP) | | −1.000 | | |
| 8(1ST SURFACE OF L3) | 4.882 | 2.029 | 1.4971 | 81.56 |
| 9(2ND SURFACE OF L3) | −22.178 | 1.030 | | |
| 10(1ST SURFACE OF L4) | −47.661 | 0.390 | 1.6155 | 25.78 |
| 11(2ND SURFACE OF L4) | 11.197 | 1.702 | | |
| 12(1ST SURFACE OF L5) | −29899.436 | 1.183 | 1.5671 | 37.56 |
| 13(2ND SURFACE OF L5) | −9.423 | 4.134 | | |
| 14(1ST SURFACE OF L6) | −6.943 | 1.509 | 1.6707 | 19.23 |
| 15(2ND SURFACE OF L6) | −5.976 | 0.807 | | |
| 16(1ST SURFACE OF L7) | 79.057 | 0.647 | 1.5445 | 56.33 |
| 17(2ND SURFACE OF L7) | 6.107 | 1.941 | | |
| 18(1ST SURFACE OF | | 0.210 | 1.5168 | 64.17 |
| OPTICAL FILTER) | | | | |
| 19(2ND SURFACE OF | | 1.221 | | |
| OPTICAL FILTER) | | | | |
| 20(IMAGING PLANE) | | | | |

TABLE 2

| OPTICAL ELEMENT | FOCAL LENGTH |
|---|---|
| PRISM | 3765.421 |
| L1 | −32.685 |
| L2 | −2000.000 |
| L3 | 8.237 |
| L4 | −14.604 |
| L5 | 16.543 |
| L6 | 38.893 |
| L7 | −12.153 |
| LG1 | −30.539 |
| LG2 | 9.550 |
| LG3 | −16.362 |

TABLE 3

| | WIDE | TELE |
|---|---|---|
| f | 16.300 | 27.220 |
| Fno | 2.396 | 3.480 |
| 2 ω | 37.032 | 22.228 |
| Σ d | 34.500 | 34.500 |
| Σ Ld1 | 2.766 | 2.766 |
| Σ Ld2 | 6.333 | 6.333 |
| Σ Ld3 | 2.962 | 2.962 |
| D6 | 6.834 | 2.052 |
| D13 | 4.134 | 1.388 |
| D17 | 1.941 | 9.468 |
| Yh | 5.320 | 5.320 |

TABLE 4

| | |
|---|---|
| −1 < ((PNd − 1.75)*PNd*100)/PVd ≤− 0.56 | −0.563 |
| 5.0 ≤ Σ d/Y h ≤ 12.0 | 6.485 |
| Σ d/f ≤ 4.0 | 2.117(WIDE) |
| | 1.267(TELE) |
| Pd/Yh > 1.3 | 1.523 |

TABLE 5

| Si | 1(1ST SURFACE OF PRISM) | 2(2ND SURFACE OF PRISM) | 3(1ST SURFACE OF L1) | 4(2ND SURFACE OF L1) |
|---|---|---|---|---|
| Ri | 20.24424929328010000000 | 17.55551830431000000000 | 6.76310820494800000000 | 4.56646228337200000000 |
| K | 0.00000000000000000000 | 0.00000000000000000000 | −2.91790683153049000000 | −2.05022257822260000000 |
| A3 | 0.00000000000000000000 | 0.00000000000000000000 | 0.00000000000000000000 | 0.00000000000000000000 |
| A4 | 0.00005181237485710890 | −0.00003588983235863000 | −0.00145914245638300000 | −0.00056104984323370000 |
| A5 | 0.00000000000000000000 | 0.00000000000000000000 | 0.00000000000000000000 | 0.00000000000000000000 |
| A6 | −0.00000029520932053362 | 0.00000395215721865600 | −0.00004380932566040000 | −0.00011393516460220000 |
| A7 | 0.00000000000000000000 | 0.00000000000000000000 | 0.00000000000000000000 | 0.00000000000000000000 |
| A8 | 0.00000000985713106701 | −0.00000017558264671760 | −0.00000125162085954700 | −0.00000150849850818900 |
| A9 | 0.00000000000000000000 | 0.00000000000000000000 | 0.00000000000000000000 | 0.00000000000000000000 |
| A10 | −0.00000000001670888877 | 0.00000000354334797099 | 0.00000015361097432080 | 0.00000030469500598230 |
| A11 | 0.00000000000000000000 | 0.00000000000000000000 | 0.00000000000000000000 | 0.00000000000000000000 |
| A12 | 0.00000000000000000000 | 0.00000000000000000000 | −0.00000000316949258393 | −0.00000000634746999257 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 5(1ST SURFACE OF L2) | 6(2ND SURFACE OF L2) | 8(1ST SURFACE OF L3) | 9(2ND SURFACE OF L3) |
|---|---|---|---|---|
| Ri | 6.04747029414500000000 | 5.72640898312200000000 | 4.88208039388900000000 | −22.17830000000000000000 |
| K | 0.00000000000000000000 | 0.00000000000000000000 | −0.41028224879799200000 | −7.84148668970792000000 |
| A3 | 0.00000000000000000000 | 0.00000000000000000000 | 0.00000000000000000000 | 0.00000000000000000000 |
| A4 | −0.00045854145408990000 | −0.00133714468448900000 | 0.00020364360290420000 | 0.00004758691652506000 |
| A5 | 0.00000000000000000000 | 0.00000000000000000000 | 0.00000000000000000000 | 0.00000000000000000000 |
| A6 | −0.00000338787211346500 | 0.00003830858830823000 | 0.00000767627650197300 | −0.00006905145503090000 |
| A7 | 0.00000000000000000000 | 0.00000000000000000000 | 0.00000000000000000000 | 0.00000000000000000000 |
| A8 | 0.00000413820979858900 | 0.00000445679706477400 | −0.00000257867406875000 | 0.00000428688998076100 |
| A9 | 0.00000000000000000000 | 0.00000000000000000000 | 0.00000000000000000000 | 0.00000000000000000000 |
| A10 | −0.00000011236176607060 | 0.00000010657466359770 | 0.00000012639072796370 | −0.00000007617446424826 |
| A11 | 0.00000000000000000000 | 0.00000000000000000000 | 0.00000000000000000000 | 0.00000000000000000000 |
| A12 | −0.00000000201196423408 | −0.00000001559127756439 | −0.00000001062939521440 | −0.00000000191658873232 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 10(1ST SURFACE OF L4) | 11(2ND SURFACE OF L4) |
|---|---|---|
| Ri | −47.66100739755000000000 | 11.19686884345000000000 |
| K | −119.17798744570400000000 | 4.67605704492226000000 |
| A3 | 0.00000000000000000000 | 0.00000000000000000000 |
| A4 | −0.00009770667632499000 | 0.00151848854422800000 |
| A5 | 0.00000000000000000000 | 0.00000000000000000000 |
| A6 | −0.00018147109508220000 | −0.00011936788748680000 |
| A7 | 0.00000000000000000000 | 0.00000000000000000000 |
| A8 | 0.00004483554375962000 | 0.00006975390321150000 |
| A9 | 0.00000000000000000000 | 0.00000000000000000000 |
| A10 | −0.00000185968538618000 | −0.00000592032690064500 |
| A11 | 0.00000000000000000000 | 0.00000000000000000000 |
| A12 | 0.00000001992393910735 | 0.00000044723731937710 |
| A13 | 0.00000000000000000000 | 0.00000000000000000000 |
| A14 | 0.00000000000000000000 | 0.00000000000000000000 |
| A15 | 0.00000000000000000000 | 0.00000000000000000000 |
| A16 | 0.00000000000000000000 | 0.00000000000000000000 |
| A17 | 0.00000000000000000000 | 0.00000000000000000000 |
| A18 | 0.00000000000000000000 | 0.00000000000000000000 |
| A19 | 0.00000000000000000000 | 0.00000000000000000000 |
| A20 | 0.00000000000000000000 | 0.00000000000000000000 |

| Si | 12(1ST SURFACE OF L5) | 13(2ND SURFACE OF L5) |
|---|---|---|
| Ri | −29899.43581698000000000000 | −9.42270537987100000000 |
| K | −1070793327771570.00000 | 3.39145986142464000000 |
| A3 | 0.00000000000000000000 | 0.00000000000000000000 |
| A4 | −0.00131763508568100000 | −0.00093456156369060000 |
| A5 | 0.00000000000000000000 | 0.00000000000000000000 |
| A6 | −0.00008745285137217000 | −0.00004358153076015000 |
| A7 | 0.00000000000000000000 | 0.00000000000000000000 |
| A8 | 0.00000951443411645500 | −0.00000455780082060700 |
| A9 | 0.00000000000000000000 | 0.00000000000000000000 |
| A10 | −0.00000199151748074600 | −0.00000004153229893850 |
| A11 | 0.00000000000000000000 | 0.00000000000000000000 |
| A12 | 0.00000018070159337490 | 0.00000001701962076018 |
| A13 | 0.00000000000000000000 | 0.00000000000000000000 |
| A14 | 0.00000000000000000000 | 0.00000000000000000000 |
| A15 | 0.00000000000000000000 | 0.00000000000000000000 |
| A16 | 0.00000000000000000000 | 0.00000000000000000000 |
| A17 | 0.00000000000000000000 | 0.00000000000000000000 |
| A18 | 0.00000000000000000000 | 0.00000000000000000000 |
| A19 | 0.00000000000000000000 | 0.00000000000000000000 |
| A20 | 0.00000000000000000000 | 0.00000000000000000000 |

| Si | 14(1ST SURFACE OF L6) | 15(2ND SURFACE OF L6) | 16(1ST SURFACE OF L7) | 17(2ND SURFACE OF L7) |
|---|---|---|---|---|
| Ri | −6.94296522018500000000 | −5.97601125526900000000 | 79.05692165891000000000 | 6.10679796961400000000 |
| K | −3.20538442814625000000 | −5.80092031271757000000 | −310.87506233318100000000 | −40.04239950334030000000 |
| A3 | 0.00000000000000000000 | 0.00000000000000000000 | 0.00000000000000000000 | 0.00000000000000000000 |
| A4 | 0.00242010304099500000 | −0.00303199704429900000 | −0.03352452546159000000 | −0.01255737367207000000 |
| A5 | 0.00000000000000000000 | 0.00000000000000000000 | 0.00000000000000000000 | 0.00000000000000000000 |
| A6 | −0.00014224754109850000 | 0.00154854692747900000 | 0.00894665594642100000 | 0.00134833892990900000 |
| A7 | 0.00000000000000000000 | 0.00000000000000000000 | 0.00000000000000000000 | 0.00000000000000000000 |
| A8 | 0.00006829473475153000 | −0.00053638803313880000 | −0.00259098217696800000 | −0.00005619436378243000 |
| A9 | 0.00000000000000000000 | 0.00000000000000000000 | 0.00000000000000000000 | 0.00000000000000000000 |
| A10 | −0.00002721973384031000 | 0.00012992844411200000 | 0.00060683964639080000 | −0.00001092370912291000 |
| A11 | 0.00000000000000000000 | 0.00000000000000000000 | 0.00000000000000000000 | 0.00000000000000000000 |
| A12 | 0.00000577834675561100 | −0.00002129699146251000 | −0.00010247077059130000 | 0.00000222763712716100 |
| A13 | 0.00000000000000000000 | 0.00000000000000000000 | 0.00000000000000000000 | 0.00000000000000000000 |
| A14 | −0.00000065048262613760 | 0.00000224401985310100 | 0.00001164043944038000 | −0.00000017103442570140 |
| A15 | 0.00000000000000000000 | 0.00000000000000000000 | 0.00000000000000000000 | 0.00000000000000000000 |
| A16 | 0.00000003891033036159 | −0.00000013608103384420 | −0.00000082355031015170 | 0.00000000538147003676 |
| A17 | 0.00000000000000000000 | 0.00000000000000000000 | 0.00000000000000000000 | 0.00000000000000000000 |
| A18 | −0.00000000107195593122 | 0.00000000380754864774 | 0.00000003200982282060 | −0.00000000000990096599 |
| A19 | 0.00000000000000000000 | 0.00000000000000000000 | 0.00000000000000000000 | 0.00000000000000000000 |
| A20 | 0.00000000000775824755 | −0.00000000002023156518 | −0.00000000051013708051 | −0.00000000000198264187 |

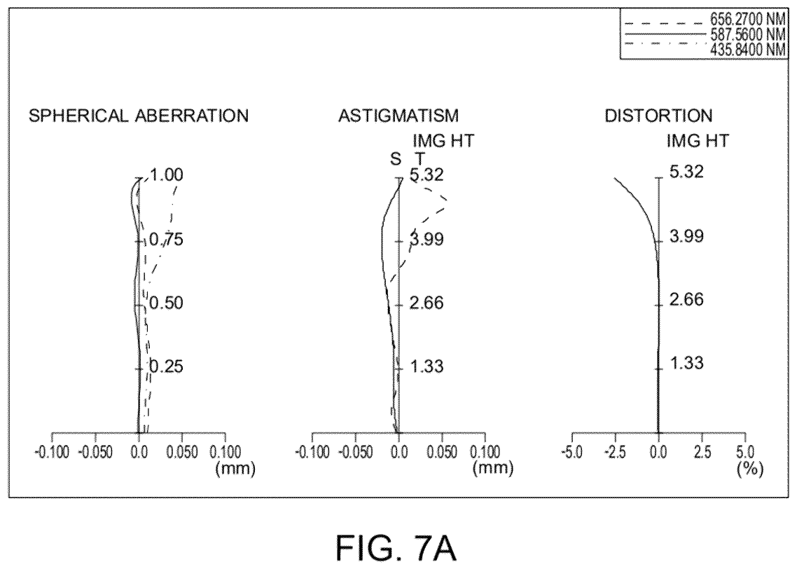

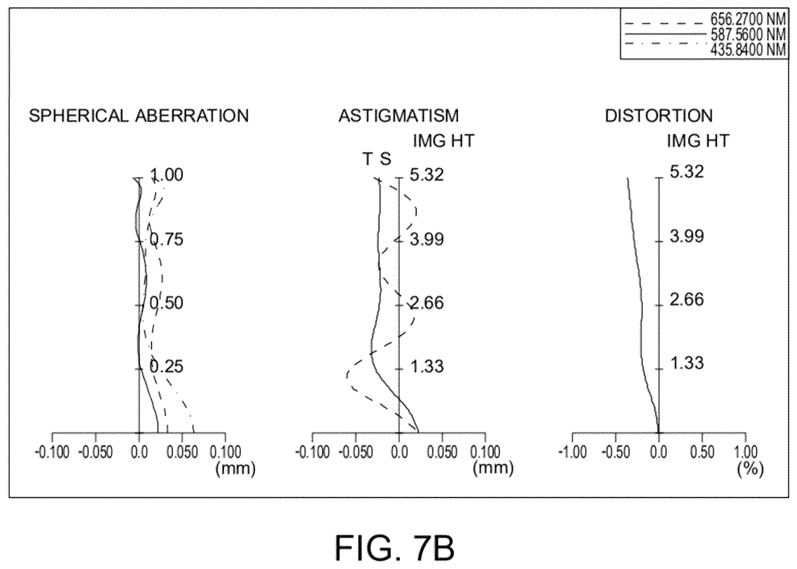

Aberrations in the first example above are shown in FIGS. 7A and 7B. FIG. 7A shows aberrations on the WIDE side. FIG. 7B shows aberrations on the TELE side. FIGS. 7A and 7B show, as examples of aberrations, spherical aberration, astigmatism (field curvature), and distortion. These aberration diagrams show aberrations with a reference wavelength at the d-line (587.56 nm). The spherical aberration diagram also shows aberrations for g-line (435.84 nm) and C-line (656.27 nm). In the aberration diagram for astigmatism, “S” denotes aberration values in a sagittal image plane, and “T” denotes aberration values in a tangential image plane. Also, “IMG HT” refers to the image height. The same applies to aberration diagrams in other examples below.

As can be seen from each aberration diagram above, it is clear that the camera module 11 in the first example may satisfactorily correct various aberrations to provide superior optical performance despite being small in size.

### Second Example

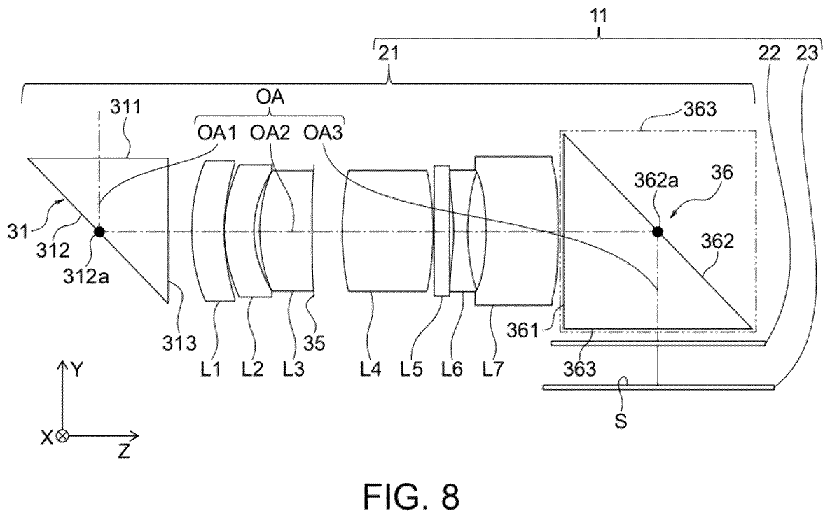

Next, a second example in which specific numerical values are applied to the camera module 11 shown in FIG. 8, will be described.

Unlike in the first example, the incident surface 311 of the prism 31 in the second example is a flat surface, and the emitting surface 313 of the prism 31 is also a flat surface. Further, in the second example, the imaging lens assembly 21 is a fixed focus lens assembly where each lens L1-L7 is fixed at a predetermined position inside the housing 4. Also, in the second example, the imaging lens assembly 21, in addition to the prism 31 (referred to as the first prism in the second example), further includes a second prism 36 disposed on the image side of the lens L7. The second prism 36 includes an incident surface 361 where light incidents from the lenses L1-L7 side, a reflective surface 362 that reflects light incident from the incident surface 361 toward the image side, and an emitting surface 363 that emits light reflected by the reflective surface 362 toward the image side. The optical axis OA further includes an optical axis OA3 which is located on the reflecting side of the reflective surface 362. The optical axes OA2 and OA3 are connected together at an intersection 362a on the reflective surface 362. Accordingly, the optical axis OA is bent twice in the second example.

In the example shown in FIG. 8, the second prism 36 emits incident light toward the −Y direction. Light emitted from the second prism 36 is imaged on the image sensor 23 which is disposed in the −Y direction of the second prism 36. However, the second example is not limited to this configuration, and the second prism 36 may emit the incident light toward the X or −X direction as well. In this case, the image sensor will be disposed in the X or −X direction of the second prism 36. In FIG. 8, a projection view of the emitting surface 363 when the second prism 36 emits the incident light toward the X or −X direction is shown with two-dot chain line. When the second prism 36 emits the incident light toward the X or −X direction, the thickness of the imaging device 1 may be further reduced since the image sensor 23 may be disposed in a direction orthogonal to the thickness direction (Y-direction) of the imaging device 1.

The lens parameters corresponding to those in the first example are as shown in Tables 6 to 10. Table 7 shows a composite focal length of the first to third lenses L1-L3 (the lens group LG1 in Table 7) and a composite focal length of the fourth to seventh lenses L4-L7 (the lens group LG2 in Table 7).

TABLE 6

| Si | Ri | Di | Ndi | v d i |
|---|---|---|---|---|
| 1(1ST SURFACE OF 1ST PRISM) | | 8.500 | 1.6503 | 21.51 |
| 2(2ND SURFACE OF 1ST PRISM) | | 1.210 | | |
| 3(1ST SURFACE OF L1) | 9.459 | 1.733 | 1.5445 | 56.33 |
| 4(2ND SURFACE OF L1) | 11.813 | 0.000 | | |
| 5(1ST SURFACE OF L2) | 7.885 | 1.590 | 1.6503 | 21.51 |
| 6(2ND SURFACE OF L2) | 5.484 | 0.356 | | |
| 7(1ST SURFACE OF L3) | 9.576 | 2.756 | 1.5445 | 56.33 |
| 8(2ND SURFACE OF L3) | 71.020 | 0.087 | | |
| 9(APERTURE STOP) | | 1.525 | | |
| 10(1ST SURFACE OF L4) | 15.405 | 4.823 | 1.5350 | 55.73 |
| 11(2ND SURFACE OF L4) | −15.717 | 0.064 | | |
| 12(1ST SURFACE OF L5) | 14085.466 | 0.902 | 1.6503 | 21.51 |
| 13(2ND SURFACE OF L5) | −1181.506 | 0.168 | | |
| 14(1ST SURFACE OF L6) | −12.469 | 0.777 | 1.5350 | 55.73 |
| 15(2ND SURFACE OF L6) | 13.305 | 0.933 | | |
| 16(1ST SURFACE OF L7) | −25.932 | 3.908 | 1.6349 | 23.97 |
| 17(2ND SURFACE OF L7) | −40.975 | 0.247 | | |
| 18(1ST SURFACE OF 2ND PRISM) | | 8.500 | 1.5445 | 56.33 |
| 19(2ND SURFACE OF 2ND | | 2.420 | | |
| PRISM) | | | | |
| 20(1ST SURFACE OF | | 0.210 | 1.5168 | 64.17 |
| OPTICAL FILTER) | | | | |
| 21(2ND SURFACE OF | | 2.123 | | |
| OPTICAL FILTER) | | | | |
| 22(IMAGING PLANE) | | | | |

TABLE 7

| OPTICAL ELEMENT | FOCAL LENGTH |
|---|---|
| L1 | 69.414 |
| L2 | −37.462 |
| L3 | 20.059 |
| L4 | 15.397 |
| L5 | 1676.022 |
| L6 | −11.926 |
| L7 | −123.731 |
| LG1 | 29.979 |
| LG2 | −97.710 |

TABLE 8

| | |
|---|---|
| f | 29.767 |
| Fno | 3.884 |
| 2 ω | 23.495 |
| Σ d | 42.833 |
| Σ Ld1 | 6.436 |
| Σ Ld2 | 11.575 |
| Yh | 6.230 |

TABLE 9

| | |
|---|---|
| −1 < ((PNd − 1.75)*PNd*100)/PVd ≤− 0.56 | −0.764(1ST PRISM) |
| 5.0 ≤ Σ d/Y h ≤ 12.0 | −0.563(2ND PRISM) |
| Σ d/f ≤ 4.0 | 6.875 |
| | 1.439 |
| Pd/Yh > 1.3 | 1.364(1ST PRISM) |
| | 1.364(2ND PRISM) |

TABLE 10

| Si | 3(1ST SURFACE OF L1) | 4(2ND SURFACE OF L1) | 5(1ST SURFACE OF L2) | 6(2ND SURFACE OF L2) |
|---|---|---|---|---|
| Ri | 9.45939930489092000000 | 11.81292689459630000000 | 7.88512762682772000000 | 5.48382487866928000000 |
| K | 0.00000000000000000000 | 0.00000000000000000000 | −3.55382538473668000000 | −1.46872942035936000000 |
| A3 | 0.00000000000000000000 | 0.00000000000000000000 | 0.00000000000000000000 | 0.00000000000000000000 |
| A4 | −0.00027197631532331700 | −0.00014485661776663100 | 0.00053259673800966700 | 0.00022174335379611300 |
| A5 | 0.00000000000000000000 | 0.00000000000000000000 | 0.00000000000000000000 | 0.00000000000000000000 |
| A6 | −0.00000571681525370804 | −0.00000439064878153708 | −0.00000726616667505654 | −0.00000260620738516305 |
| A7 | 0.00000000000000000000 | 0.00000000000000000000 | 0.00000000000000000000 | 0.00000000000000000000 |
| A8 | 0.00000014515170527060 | 0.00000006465142448717 | −0.00000005383915929823 | −0.00000020105572936433 |
| A9 | 0.00000000000000000000 | 0.00000000000000000000 | 0.00000000000000000000 | 0.00000000000000000000 |
| A10 | 0.00000000000000000000 | 0.00000000000000000000 | −0.00000000120918643650 | 0.00000000722744355054 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |
| Si | 7(1ST SURFACE OF L3) | 8(2ND SURFACE OF L3) | 10(1ST SURFACE OF L4) | 11(2ND SURFACE OF L4) |
| Ri | 9.57576717900480000000 | 71.01999825574670000000 | 15.40479456967910000000 | −15.71736261852970000000 |
| K | 0.00000000000000000000 | 0.00000000000000000000 | 0.00000000000000000000 | −9.01054107971444000000 |
| A3 | 0.00000000000000000000 | 0.00000000000000000000 | 0.00000000000000000000 | 0.00000000000000000000 |
| A4 | 0.00031993979303385700 | 0.00017643525394826300 | −0.00042340618641050600 | 0.00010815271050064300 |
| A5 | 0.00000000000000000000 | 0.00000000000000000000 | 0.00000000000000000000 | 0.00000000000000000000 |
| A6 | −0.00000624913645625000 | 0.00000830594478877267 | 0.00001311723607227760 | −0.00000227705016764340 |
| A7 | 0.00000000000000000000 | 0.00000000000000000000 | 0.00000000000000000000 | 0.00000000000000000000 |
| A8 | 0.00000029211666450082 | 0.00000004812586798857 | 0.00000002187578140294 | −0.00000059982127088459 |
| A9 | 0.00000000000000000000 | 0.00000000000000000000 | 0.00000000000000000000 | 0.00000000000000000000 |
| A10 | −0.00000001233338998378 | −0.00000003757130553746 | −0.00000002127552384986 | 0.00000012650839860548 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 12(1ST SURFACE OF L5) | 13(2ND SURFACE OF L5) | 14(1ST SURFACE OF L6) | 15(2ND SURFACE OF L6) |
|---|---|---|---|---|
| Ri | 14085.46607843730000000000 | −1181.5056363222200000 | −12.46867140763300000000 | 13.30517444732340000000 |
| K | −6902144003940990.000000 | 0.00000000000000000000 | 0.00000000000000000000 | 10.00000000000000000000 |
| A3 | 0.00000000000000000000 | 0.00000000000000000000 | 0.00000000000000000000 | 0.00000000000000000000 |
| A4 | 0.00059809801007115600 | 0.00014668124430587300 | 0.00265936608817596000 | −0.00025686223900501100 |
| A5 | 0.00000000000000000000 | 0.00000000000000000000 | 0.00006963582923375940 | 0.00008231789632482670 |
| A6 | −0.00008482355494011960 | −0.00010678068067390500 | −0.00009361224217566670 | 0.00005678858357352390 |
| A7 | 0.00000000000000000000 | 0.00000000000000000000 | 0.00000512013042946213 | −0.00000400437121285043 |
| A8 | 0.00000154899289145852 | 0.00000246975979974207 | −0.00000383007784341785 | −0.00000720155841038525 |
| A9 | 0.00000000000000000000 | 0.00000000000000000000 | −0.00000032083623686730 | −0.00000000471780563744 |
| A10 | 0.00000010126624542015 | 0.00000016366604960829 | 0.00000035006705667569 | 0.00000009766492114085 |
| A11 | 0.00000000000000000000 | 0.00000000000000000000 | 0.00000002357883272874 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 16(1ST SURFACE OF L7) | 17(2ND SURFACE OF L7) |
|---|---|---|
| Ri | −25.93190824815110000000 | −40.97500084090720000000 |
| K | 0.00000000000000000000 | 0.00000000000000000000 |
| A3 | 0.00000000000000000000 | 0.00000000000000000000 |
| A4 | −0.00320547910986914000 | −0.00097060444668288500 |
| A5 | 0.00000000000000000000 | 0.00000000000000000000 |
| A6 | 0.00006350542214580560 | 0.00001964904890072690 |
| A7 | 0.00000000000000000000 | 0.00000000000000000000 |
| A8 | −0.00000063895091627330 | −0.00000010471516740962 |
| A9 | 0.00000000000000000000 | 0.00000000000000000000 |
| A10 | 0.00000000000000000000 | 0.00000000000000000000 |
| A11 | 0.00000000000000000000 | 0.00000000000000000000 |
| A12 | 0.00000000000000000000 | 0.00000000000000000000 |
| A13 | 0.00000000000000000000 | 0.00000000000000000000 |
| A14 | 0.00000000000000000000 | 0.00000000000000000000 |
| A15 | 0.00000000000000000000 | 0.00000000000000000000 |
| A16 | 0.00000000000000000000 | 0.00000000000000000000 |
| A17 | 0.00000000000000000000 | 0.00000000000000000000 |
| A18 | 0.00000000000000000000 | 0.00000000000000000000 |
| A19 | 0.00000000000000000000 | 0.00000000000000000000 |
| A20 | 0.00000000000000000000 | 0.00000000000000000000 |

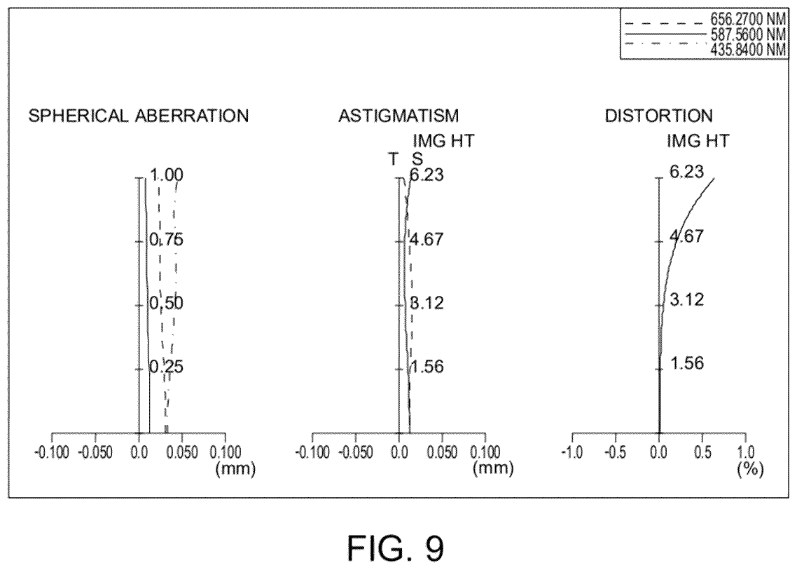

Aberrations in the second example are shown in FIG. 9. According to the imaging lens assembly 21 of the second example, by adding the second prism 36 to the first example, the focal length may be extended while maintaining the small configuration. Further, according to the imaging lens assembly 21 of the second example, by making the lens parameters different from those of the first example, the degree of freedom in designing the camera module 11 may be further increased while obtaining the same effects as in the first example.

### Third Example

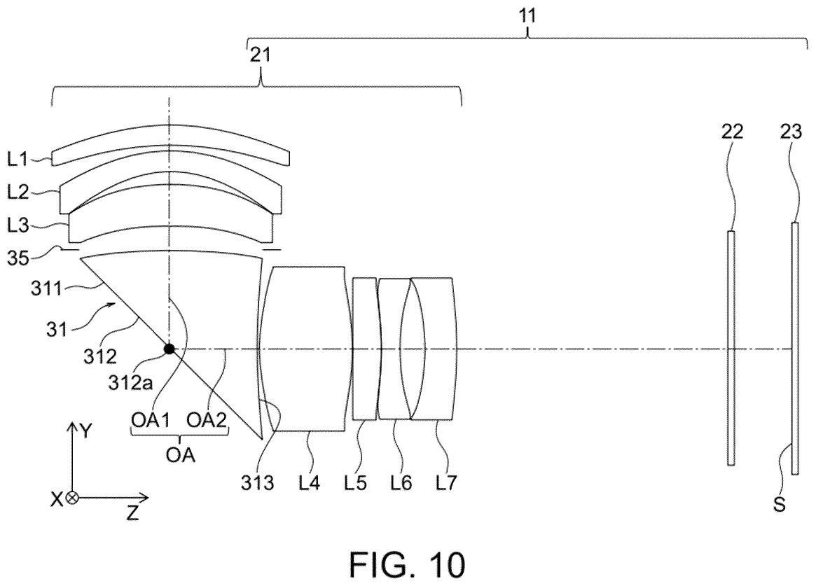

Next, a third example in which specific numerical values are applied to the camera module 11 shown in FIG. 10, will be described.

Unlike in the first example, the imaging lens assembly 21 in the third example includes lenses L1-L3 that are disposed on the object side of the prism 31. In other words, in the third example, the first to third lenses L1-L3 are disposed on the object side of the prism 31 and the fourth to seventh lenses L4-L7 are disposed on the image side of the prism. Further, in the third example, the imaging lens assembly 21 is the fixed focus lens assembly where each lens L1-L7 is fixed at the predetermined position inside the housing 4.

The lens parameters corresponding to those in the first example are as shown in Tables 11 to 15.

Also, Table 12 shows a composite focal length of the first to third lenses L1-L3 (the lens group LG1 in Table 12) and a composite focal length of the fourth to seventh lenses L4-L7 (the lens group LG2 in Table 12).

TABLE 11

| Si | Ri | Di | Ndi | ν di |
|---|---|---|---|---|
| 1(1ST SURFACE OF L1) | 9.566 | 0.820 | 1.5445 | 56.33 |
| 2(2ND SURFACE OF L1) | 12.365 | 0.200 | | |
| 3(1ST SURFACE OF L2) | 6.631 | 0.855 | 1.6503 | 21.51 |
| 4(2ND SURFACE OF L2) | 4.967 | 0.474 | | |
| 5(1ST SURFACE OF L3) | 8.459 | 1.694 | 1.5445 | 56.33 |
| 6(2ND SURFACE OF L3) | 12.723 | 0.987 | | |
| 7(APERTURE STOP) | | 0.000 | | |
| 8(1ST SURFACE OF PRISM) | 21.930 | 7.500 | 1.5445 | 56.33 |
| 9(2ND SURFACE OF PRISM) | 22.310 | 0.150 | | |
| 10(1ST SURFACE OF L4) | 10.292 | 3.691 | 1.5350 | 55.73 |
| 11(2ND SURFACE OF L4) | −10.354 | 0.050 | | |
| 12(1ST SURFACE OF L5) | 104361.302 | 1.091 | 1.6503 | 21.51 |
| 13(2ND SURFACE OF L5) | −25.760 | 0.049 | | |
| 14(1ST SURFACE OF L6) | −10.012 | 0.747 | 1.5350 | 55.73 |
| 15(2ND SURFACE OF L6) | 10.985 | 0.977 | | |
| 16(1ST SURFACE OF L7) | −13.334 | 1.265 | 1.6349 | 23.97 |
| 17(2ND SURFACE OF L7) | −38.356 | 10.911 | | |
| 18(1ST SURFACE OF | | 0.210 | 1.5168 | 64.17 |
| OPTICAL FILTER) | | | | |
| 19(2ND SURFACE OF | | 2.330 | | |
| OPTICAL FILTER) | | | | |
| 20(IMAGING PLANE) | | | | |

TABLE 12

| OPTICAL ELEMENT | FOCAL LENGTH |
|---|---|
| L1 | 70.520 |
| L2 | −38.164 |
| L3 | 40.767 |
| PRISM | 298.253 |
| L4 | 11.332 |
| L5 | 39.597 |
| L6 | −9.687 |
| L7 | −32.838 |
| LG1 | 84.893 |
| LG2 | 57.660 |

TABLE 13

| | |
|---|---|
| f | 32.800 |
| Fno | 3.766 |
| 2ω | 17.452 |
| Σ d | 32.800 |
| Σ Ld1 | 4.043 |
| Σ Ld2 | 7.869 |
| Yh | 5.161 |

TABLE 14

| | |
|---|---|
| −1 < ((PNd − 1.75)*PNd*100)/PVd ≤ −0.56 | −0.563 |
| 5.0 ≤ Σ d/Yh ≤ 12.0 | 6.356 |
| Σ d / f ≤ 4.0 | 1.000 |
| Pd/Yh > 1.3 | 1.453 |

TABLE 15

| Si | 1(1ST SURFACE OF L1) | 2(2ND SURFACE OF L1) | 3(1ST SURFACE OF L2) | 4(2ND SURFACE OF L2) |
|---|---|---|---|---|
| Ri | 9.56561412874842000000 | 12.36459802398980000000 | 6.63065526314952000000 | 4.96686559018339000000 |
| K | 0.00000000000000000000 | 0.00000000000000000000 | −3.56491003302338000000 | −1.43516779085927000000 |
| A3 | 0.00000000000000000000 | 0.00000000000000000000 | 0.00000000000000000000 | 0.00000000000000000000 |
| A4 | −0.00043149728950455100 | −0.00024618843972865700 | 0.00093806799179381200 | 0.00043936609085930200 |
| A5 | 0.00000000000000000000 | 0.00000000000000000000 | 0.00000000000000000000 | 0.00000000000000000000 |
| A6 | −0.00001248862955337900 | −0.00001157183459206700 | −0.00001927511695001430 | −0.00000251803586455481 |
| A7 | 0.00000000000000000000 | 0.00000000000000000000 | 0.00000000000000000000 | 0.00000000000000000000 |
| A8 | 0.00000059997351281469 | 0.00000058070669065510 | −0.00000013464343754573 | −0.00000047372336336280 |
| A9 | 0.00000000000000000000 | 0.00000000000000000000 | 0.00000000000000000000 | 0.00000000000000000000 |
| A10 | 0.00000000000000000000 | 0.00000000000000000000 | 0.00000000178661102488 | −0.00000000187828377633 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 5(1ST SURFACE OF L3) | 6(2ND SURFACE OF L3) | 8(1ST SURFACE OF PRISM) | 9(2ND SURFACE OF PRISM) |
|---|---|---|---|---|
| Ri | 8.45939456879949000000 | 12.72342735194170000000 | 21.93038315577580000000 | 22.31041508215570000000 |
| K | 0.00000000000000000000 | 0.00000000000000000000 | 0.00000000000000000000 | 0.00000000000000000000 |
| A3 | 0.00000000000000000000 | 0.00000000000000000000 | 0.00000000000000000000 | 0.00000000000000000000 |
| A4 | 0.00045977209456186800 | 0.00034221923245379400 | 0.00002996288679954510 | −0.00022151444617730100 |
| A5 | 0.00000000000000000000 | 0.00000000000000000000 | 0.00000000000000000000 | 0.00000000000000000000 |
| A6 | −0.00001181040052410170 | 0.00000683267901209160 | 0.00000276621779780693 | 0.00002202289064663640 |
| A7 | 0.00000000000000000000 | 0.00000000000000000000 | 0.00000000000000000000 | 0.00000000000000000000 |
| A8 | 0.00000133953812795263 | 0.00000095421050320591 | 0.00000026915149849357 | −0.00000020143479325763 |
| A9 | 0.00000000000000000000 | 0.00000000000000000000 | 0.00000000000000000000 | 0.00000000000000000000 |
| A10 | −0.00000003899556990900 | −0.00000002541653418540 | −0.00000000254311411212 | −0.00000004160341446975 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 10(1ST SURFACE OF L4) | 11(2ND SURFACE OF L4) | 12(1ST SURFACE OF L5) | 13(2ND SURFACE OF L5) |
|---|---|---|---|---|
| Ri | 10.29214148374170000000 | −10.35398813364320000000 | 104361.30245879600000000000 | −25.76032110149850000000 |
| K | 0.00000000000000000000 | −14.69527805395090000000 | −492507212835405000000.00000 | 0.00000000000000000000 |
| A3 | 0.00000000000000000000 | 0.00000000000000000000 | 0.00000000000000000000 | 0.00000000000000000000 |
| A4 | −0.00059758585308646400 | 0.00031804309392727500 | 0.00113368076668990000 | 0.00030538905780283500 |
| A5 | 0.00000000000000000000 | 0.00000000000000000000 | 0.00000000000000000000 | 0.00000000000000000000 |
| A6 | 0.00004070616486307050 | −0.00000309446971886415 | −0.00023126838054283300 | −0.00024522274833108000 |
| A7 | 0.00000000000000000000 | 0.00000000000000000000 | 0.00000000000000000000 | 0.00000000000000000000 |
| A8 | −0.00000079326971461502 | −0.00000249772175025767 | 0.00000310596993633150 | 0.00001130992866515200 |
| A9 | 0.00000000000000000000 | 0.00000000000000000000 | 0.00000000000000000000 | 0.00000000000000000000 |
| A10 | −0.00000006081503968376 | 0.00000036296428434503 | 0.00000078134460466956 | 0.00000029739166270174 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 14(1ST SURFACE OF L6) | 15(2ND SURFACE OF L6) | 16(1ST SURFACE OF L7) | 17(2ND SURFACE OF L7) |
|---|---|---|---|---|
| Ri | −10.01197873424760000000 | 10.98542514525570000000 | −13.33445082994470000000 | −38.35565413135210000000 |
| K | 0.00000000000000000000 | 10.00000000000000000000 | 0.00000000000000000000 | 0.00000000000000000000 |
| A3 | 0.00000000000000000000 | 0.00000000000000000000 | 0.00000000000000000000 | 0.00000000000000000000 |
| A4 | 0.00495878294949849000 | 0.00020593554573169200 | −0.00492831172031778000 | −0.00214659992980415000 |
| A5 | 0.00023832660264804000 | 0.00020078985028485100 | 0.00000000000000000000 | 0.00000000000000000000 |
| A6 | −0.00019780136488669200 | 0.00006017747865466270 | 0.00012201355015631900 | 0.00012295464754356300 |
| A7 | 0.00002870469995018090 | −0.00002649789722407710 | 0.00000000000000000000 | 0.00000000000000000000 |
| A8 | −0.00001246007795508540 | −0.00002084090575556790 | −0.00000205082560194584 | −0.00000027226159815861 |
| A9 | −0.00000160146958448191 | 0.00000310620674859950 | 0.00000000000000000000 | 0.00000000000000000000 |
| A10 | 0.00000160835865835387 | −0.00000026085796537665 | 0.00000000000000000000 | 0.00000000000000000000 |
| A11 | −0.00000005985112259001 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

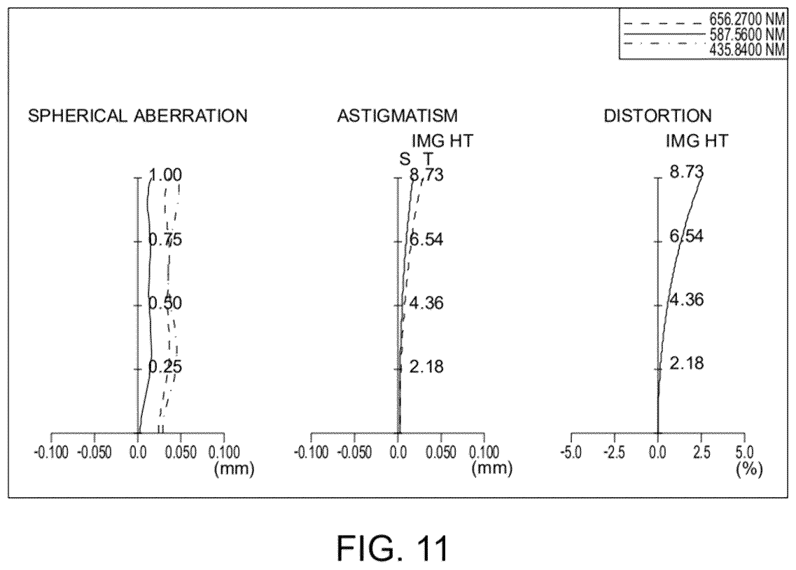

Aberrations in the third example are shown in FIG. 11. According to the third example, by making the lens arrangement and the lens parameters different from those of the first example, the degree of freedom in designing the camera module 11 may be further increased while obtaining the same effects as in the first example.

### Fourth Example

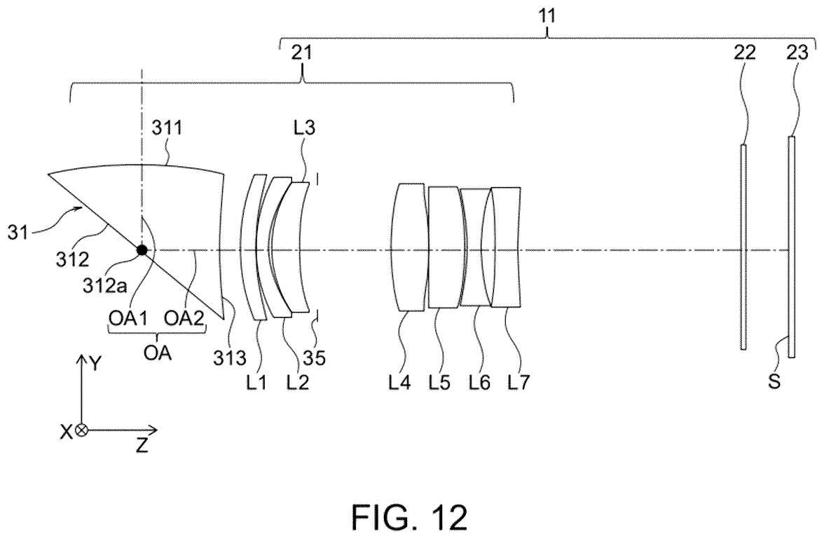

Next, a fourth example in which specific numerical values are applied to the camera module 11 shown in FIG. 12, will be described.

Unlike in the first example, the imaging lens assembly 21 in the fourth example is the fixed focus lens assembly where each lens L1-L7 is fixed at the predetermined position inside the housing 4.

The lens parameters corresponding to those in the first example are as shown in Tables 16 to 20. Table 17 shows a composite focal length of the first to third lenses L1-L3 (the lens group LG1 in Table 17) and a composite focal length of the fourth to seventh lenses L4-L7 (the lens group LG2 in Table 17).

TABLE 16

| Si | Ri | Di | Ndi | ν di |
|---|---|---|---|---|
| 1(1ST SURFACE OF PRISM) | 21.213 | 8.500 | 1.5445 | 56.33 |
| 2(2ND SURFACE OF PRISM) | 25.269 | 1.000 | | |
| 3(1ST SURFACE OF L1) | 8.558 | 0.746 | 1.5445 | 56.33 |
| 4(2ND SURFACE OF L1) | 10.385 | 0.007 | | |
| 5(1ST SURFACE OF L2) | 6.740 | 0.604 | 1.6503 | 21.51 |
| 6(2ND SURFACE OF L2) | 4.648 | 0.155 | | |
| 7(1ST SURFACE OF L3) | 5.909 | 1.284 | 1.5445 | 56.33 |
| 8(2ND SURFACE OF L3) | 10.970 | 0.913 | | |
| 9(APERTURE STOP) | | 3.483 | | |
| 10(1ST SURFACE OF L4) | 13.092 | 1.787 | 1.5350 | 55.73 |
| 11(2ND SURFACE OF L4) | −11.491 | 0.010 | | |
| 12(1ST SURFACE OF L5) | 111206.133 | 1.695 | 1.6503 | 21.51 |
| 13(2ND SURFACE OF L5) | −14.511 | 0.116 | | |
| 14(1ST SURFACE OF L6) | −7.869 | 0.694 | 1.5350 | 55.73 |
| 15(2ND SURFACE OF L6) | 11.561 | 0.665 | | |
| 16(1ST SURFACE OF L7) | −303.155 | 1.093 | 1.6349 | 23.97 |
| 17(2ND SURFACE OF L7) | 20.904 | 10.648 | | |
| 18(1ST SURFACE OF | | 0.210 | 1.5168 | 64.17 |
| OPTICAL FILTER) | | | | |
| 19(2ND SURFACE OF | | 2.006 | | |
| OPTICAL FILTER) | | | | |
| 20(IMAGING PLANE) | | | | |

TABLE 17

| OPTICAL ELEMENT | FOCAL LENGTH |
|---|---|
| PRISM | 140.017 |
| L1 | 78.316 |
| L2 | −25.975 |
| L3 | 21.647 |
| L4 | 11.756 |
| L5 | 22.308 |
| L6 | −8.658 |
| L7 | −30.759 |
| LG1 | 54.727 |
| LG2 | 363.066 |

TABLE 18

| | |
|---|---|
| f | 32.000 |
| Fno | 3.900 |
| 2ω | 18.350 |
| Σ d | 35.615 |
| Σ Ld1 | 2.796 |
| Σ Ld2 | 6.059 |
| Yh | 5.350 |

TABLE 19

| | |
|---|---|
| −1 < ((PNd − 1.75)*PNd*100)/PVd ≤ −0.56 | −0.563 |
| 5.0 ≤ Σ d/Yh ≤ 12.0 | 6.657 |
| Σ d/ f ≤ 4.0 | 1.113 |
| Pd/Yh > 1.3 | 1.589 |

TABLE 20

| Si | 1 (1ST SURFACE OF PRISM) | 2(2ND SURFACE OF PRISM) | 3(1ST SURFACE OF L1) | 4(2ND SURFACE OF L1) |
|---|---|---|---|---|
| Ri | 21.21330815981910000000 | 25.26921023479380000000 | 8.55801814763528000000 | 10.38451285483500000000 |
| K | 0.00000000000000000000 | 0.00000000000000000000 | 0.00000000000000000000 | 0.00000000000000000000 |
| A3 | 0.00000000000000000000 | 0.00000000000000000000 | 0.00000000000000000000 | 0.00000000000000000000 |
| A4 | 0.00000176911577370329 | 0.00000232299917447393 | −0.00048562439927489900 | −0.00026677194473138400 |
| A5 | 0.00000000000000000000 | 0.00000000000000000000 | 0.00000000000000000000 | 0.00000000000000000000 |
| A6 | 0.00000001237590142399 | 0.00000020312970073023 | −0.00001103014019994120 | −0.00001239462503466350 |
| A7 | 0.00000000000000000000 | 0.00000000000000000000 | 0.00000000000000000000 | 0.00000000000000000000 |
| A8 | 0.00000000748887915815 | 0.00000002949044119141 | 0.00000074074426714215 | 0.00000032141112673453 |
| A9 | 0.00000000000000000000 | 0.00000000000000000000 | 0.00000000000000000000 | 0.00000000000000000000 |
| A10 | −0.00000000014627509605 | 0.00000000132361437626 | 0.00000000000000000000 | 0.00000000000000000000 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 5(1ST SURFACE OF L2) | 6(2ND SURFACE OF L2) | 7(1ST SURFACE OF L3) | 8(2ND SURFACE OF L3) |
|---|---|---|---|---|
| Ri | 6.74016214273568000000 | 4.64773608485495000000 | 5.90914345686998000000 | 10.96992373440510000000 |
| K | −4.06102988296699000000 | −1.33503440836964000000 | 0.00000000000000000000 | 0.00000000000000000000 |
| A3 | 0.00000000000000000000 | 0.00000000000000000000 | 0.00000000000000000000 | 0.00000000000000000000 |
| A4 | 0.00087494547634357900 | 0.00054123226120788300 | 0.00050295283039177900 | 0.00024542651690370000 |
| A5 | 0.00000000000000000000 | 0.00000000000000000000 | 0.00000000000000000000 | 0.00000000000000000000 |
| A6 | −0.00002143969041819500 | 0.00000439831301967734 | −0.00001746539419650440 | 0.00001165123173091880 |
| A7 | 0.00000000000000000000 | 0.00000000000000000000 | 0.00000000000000000000 | 0.00000000000000000000 |
| A8 | −0.00000019661245406610 | −0.00000029139823508663 | 0.00000128692136254829 | 0.00000065547585567586 |
| A9 | 0.00000000000000000000 | 0.00000000000000000000 | 0.00000000000000000000 | 0.00000000000000000000 |
| A10 | −0.00000000268405618778 | 0.00000001525780660906 | −0.00000002134529857689 | −0.00000003398806331712 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 10(1ST SURFACE OF L4) | 11(2ND SURFACE OF L4) | 12(1ST SURFACE OF L5) | 13(2ND SURFACE OF L5) |
|---|---|---|---|---|
| Ri | 13.09234189530570000000 | −11.49143528316950000000 | 111206.13271181600000000000 | −14.51122394987110000000 |
| K | 0.00000000000000000000 | −15.07815124225330000000 | −135446213760916000000 | 0.00000000000000000000 |
| A3 | 0.00000000000000000000 | 0.00000000000000000000 | 0.00000000000000000000 | 0.00000000000000000000 |
| A4 | −0.00059116404810322100 | 0.00026760365948755500 | 0.00141357165774140000 | 0.00030898290608079900 |
| A5 | 0.00000000000000000000 | 0.00000000000000000000 | 0.00000000000000000000 | 0.00000000000000000000 |
| A6 | 0.00008815718837345650 | 0.00001358378330957630 | −0.00020763675068060700 | −0.00023500144370281100 |
| A7 | 0.00000000000000000000 | 0.00000000000000000000 | 0.00000000000000000000 | 0.00000000000000000000 |
| A8 | 0.00000012546752406484 | 0.00000146815893504167 | 0.00000334053928891189 | 0.00001013610803312390 |
| A9 | 0.00000000000000000000 | 0.00000000000000000000 | 0.00000000000000000000 | 0.00000000000000000000 |
| A10 | −0.00000000492635539392 | 0.00000034890302348476 | 0.00000069238929419744 | 0.00000041365008174577 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 14(1ST SURFACE OF L6) | 15(2ND SURFACE OF L6) | 16(1ST SURFACE OF L7) | 17(2ND SURFACE OF L7) |
|---|---|---|---|---|
| Ri | −7.86870827340071000000 | 11.56058332021690000000 | −303.15526506350500000000 | 20.90409804512980000000 |
| K | 0.00000000000000000000 | 10.00000000000000000000 | 0.00000000000000000000 | 0.00000000000000000000 |
| A3 | 0.00000000000000000000 | 0.00000000000000000000 | 0.00000000000000000000 | 0.00000000000000000000 |
| A4 | 0.00447140026641576000 | 0.00030400260794748300 | −0.00496673877695304000 | −0.00245528000613579000 |
| A5 | 0.00010921083650086700 | 0.00002186745242761260 | 0.00000000000000000000 | 0.00000000000000000000 |
| A6 | −0.00026615863657932300 | 0.00010474183604213500 | 0.00021204328924745400 | 0.00012858668865208300 |
| A7 | 0.00001222603700556130 | −0.00001428288740788180 | 0.00000000000000000000 | 0.00000000000000000000 |
| A8 | −0.00001304501575204350 | −0.00002695523377523740 | −0.00000346451924538454 | −0.00000020880687029618 |
| A9 | −0.00000056798536721777 | −0.00000028553966867978 | 0.00000000000000000000 | 0.00000000000000000000 |
| A10 | 0.00000191163435112510 | 0.00000038354875573762 | 0.00000000000000000000 | 0.00000000000000000000 |
| A11 | −0.00000018872448763357 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

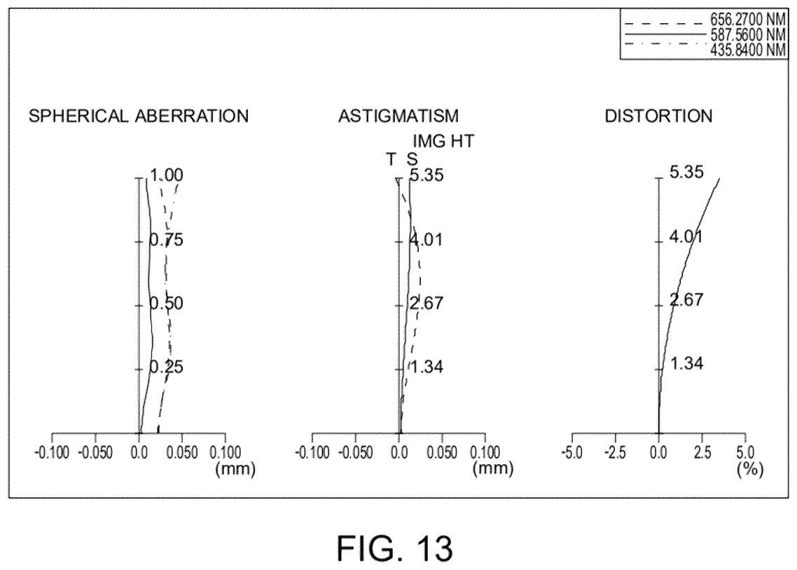

Aberrations in the fourth example are shown in FIG. 13. According to the imaging lens assembly 21 of the fourth example, by making the lens configuration and the lens parameters different from those of the first example, the degree of freedom in designing the camera module 11 may be further increased while obtaining the same effects as in the first example.

### Fifth Example

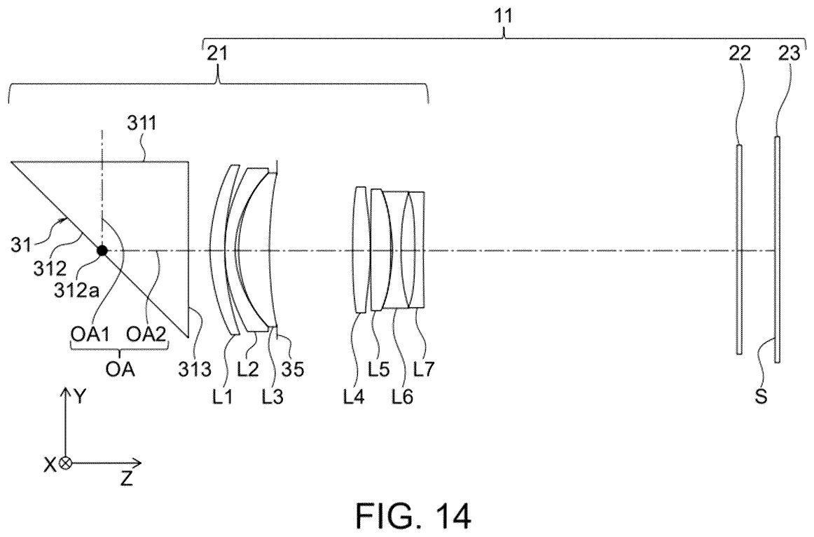

Next, a fifth example in which specific numerical values are applied to the camera module 11 shown in FIG. 14, will be described.

Unlike in the first example, the incident surface 311 of the prism 31 in the fifth example is a flat surface, and the emitting surface 313 of the prism 31 is also a flat surface. Further, in the fifth example, the imaging lens assembly 21 is the fixed focus lens assembly where each lens L1-L7 is fixed at the predetermined inside the housing 4.

The lens parameters corresponding to those in the first example are as shown in Tables 21 to 25. Table 22 shows a composite focal length of the first to third lenses L1-L3 (the lens group LG1 in Table 22) and a composite focal length of the fourth to seventh lenses L4-L7 (the lens group LG2 in Table 22).

TABLE 21

| Si | Ri | Di | Ndi | ν di |
|---|---|---|---|---|
| 1(1ST SURFACE OF PRISM) | | 8.500 | 1.6503 | 21.51 |
| 2(2ND SURFACE OF PRISM) | | 1.000 | | |
| 3(1ST SURFACE OF L1) | 8.125 | 0.687 | 1.5445 | 56.33 |
| 4(2ND SURFACE OF L1) | 10.462 | 0.000 | | |
| 5(1ST SURFACE OF L2) | 6.739 | 0.510 | 1.6503 | 21.51 |
| 6(2ND SURFACE OF L2) | 4.660 | 0.141 | | |
| 7(1ST SURFACE OF L3) | 5.932 | 1.490 | 1.5445 | 56.33 |
| 8(2ND SURFACE OF L3) | 27.400 | 0.330 | | |
| 9(APERTURE STOP) | | 3.636 | | |
| 10(1ST SURFACE OF L4) | 31.066 | 0.869 | 1.5350 | 55.73 |
| 11(2ND SURFACE OF L4) | −11.453 | 0.000 | | |
| 12(1ST SURFACE OF L5) | 22734.394 | 0.969 | 1.6503 | 21.51 |
| 13(2ND SURFACE OF L5) | −10.871 | 0.063 | | |
| 14(1ST SURFACE OF L6) | −6.601 | 0.400 | 1.5350 | 55.73 |
| 15(2ND SURFACE OF L6) | 11.723 | 0.680 | | |
| 16(1ST SURFACE OF L7) | −46.569 | 0.400 | 1.6349 | 23.97 |
| 17(2ND SURFACE OF L7) | 24.177 | 15.000 | | |
| 18(1ST SURFACE OF | | 0.210 | 1.5168 | 64.17 |
| OPTICAL FILTER) | | | | |
| 19(2ND SURFACE OF | | 1.616 | | |
| OPTICAL FILTER) | | | | |
| 20(IMAGING PLANE) | | | | |

TABLE 22

| OPTICAL ELEMENT | FOCAL LENGTH |
|---|---|
| L1 | 60.671 |
| L2 | −25.699 |
| L3 | 13.607 |
| L4 | 15.780 |
| L5 | 16.707 |
| L6 | −7.848 |
| L7 | −25.010 |
| LG1 | 20.806 |
| LG2 | −27.826 |

TABLE 23

| | |
|---|---|
| f | 32.000 |
| Fno | 3.925 |
| 2ω | 18.454 |
| Σ d | 36.500 |
| Σ Ld1 | 2.828 |
| Σ Ld2 | 3.380 |
| Yh | 5.350 |

TABLE 24

| | |
|---|---|
| −1 < ((PNd − 1.75)*PNd*100)/PVd ≤ −0.56 | −0.764 |
| 5.0 ≤ Σ d /Yh ≤ 12.0 | 6.822 |
| Σ d/ f ≤ 4.0 | 1.141 |
| Pd/Yh > 1.3 | 1.589 |

TABLE 25

| Si | 3(1ST SURFACE OF L1) | 4(2ND SURFACE OF L1) | 5(1ST SURFACE OF L2) | 6(2ND SURFACE OF L2) |
|---|---|---|---|---|
| Ri | 8.12496855700958000000 | 10.46231536030100000000 | 6.73915004997853000000 | 4.65959525355113000000 |
| K | 0.00000000000000000000 | 0.00000000000000000000 | −4.09374979897382000000 | −1.33204209114853000000 |
| A3 | 0.00000000000000000000 | 0.00000000000000000000 | 0.00000000000000000000 | 0.00000000000000000000 |
| A4 | −0.00048358222455593100 | −0.00026883804522427600 | 0.00087450822615692300 | 0.00054385438054302200 |
| A5 | 0.00000000000000000000 | 0.00000000000000000000 | 0.00000000000000000000 | 0.00000000000000000000 |
| A6 | −0.00001038069313319340 | −0.00001295007162192050 | −0.00002129794056619090 | 0.00000443851804363908 |
| A7 | 0.00000000000000000000 | 0.00000000000000000000 | 0.00000000000000000000 | 0.00000000000000000000 |
| A8 | 0.00000079118151287943 | 0.00000028904327057408 | −0.00000019919906304543 | −0.00000027703440884703 |
| A9 | 0.00000000000000000000 | 0.00000000000000000000 | 0.00000000000000000000 | 0.00000000000000000000 |
| A10 | 0.00000000000000000000 | 0.00000000000000000000 | −0.00000000413833148091 | 0.00000001533508332763 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 7(1ST SURFACE OF L3) | 8(2ND SURFACE OF L3) | 10(1ST SURFACE OF L4) | 11(2ND SURFACE OF L4) |
|---|---|---|---|---|
| Ri | 5.93239925632444000000 | 27.39991934231900000000 | 31.06640784624370000000 | −11.45317169697090000000 |
| K | 0.00000000000000000000 | 0.00000000000000000000 | 0.00000000000000000000 | −15.83026946864800000000 |
| A3 | 0.00000000000000000000 | 0.00000000000000000000 | 0.00000000000000000000 | 0.00000000000000000000 |
| A4 | 0.00049492299985042600 | 0.00025493963912486200 | −0.00062777776177860500 | 0.00029701079396498800 |
| A5 | 0.00000000000000000000 | 0.00000000000000000000 | 0.00000000000000000000 | 0.00000000000000000000 |
| A6 | −0.00001745533781732290 | 0.00001151113650150580 | 0.00008752551337119740 | 0.00001600642621638800 |
| A7 | 0.00000000000000000000 | 0.00000000000000000000 | 0.00000000000000000000 | 0.00000000000000000000 |
| A8 | 0.00000129726571976370 | 0.00000071278775994662 | 0.00000010566697536513 | 0.00000169255977717527 |
| A9 | 0.00000000000000000000 | 0.00000000000000000000 | 0.00000000000000000000 | 0.00000000000000000000 |
| A10 | −0.00000001792042543495 | −0.00000002670385959936 | 0.00000003493246414468 | 0.00000035211211545533 |
| A11 | 0.00000000000000000000 | 0.00000000000000000000 | 0.00000000000000000000 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 12(1ST SURFACE OF L5) | 13(2ND SURFACE OF L5) | 14(1ST SURFACE OF L6) | 15(2ND SURFACE OF L6) |
|---|---|---|---|---|
| Ri | 22734.39414007690000000000 | −10.87132243789750000000 | −6.60122416517268000000 | 11.72318314338740000000 |
| K | −49498288670.4767000000 | 0.00000000000000000000 | 0.00000000000000000000 | 10.00000000000000000000 |
| A3 | 0.00000000000000000000 | 0.00000000000000000000 | 0.00000000000000000000 | 0.00000000000000000000 |
| A4 | 0.00142136539459063000 | 0.00029744143434675700 | 0.00446864057280213000 | 0.00027310278491501600 |
| A5 | 0.00000000000000000000 | 0.00000000000000000000 | 0.00010173728215338900 | 0.00004239239356688480 |
| A6 | −0.00020686629465907800 | −0.00023351927313723900 | −0.00026695584331964300 | 0.00010686943542004600 |
| A7 | 0.00000000000000000000 | 0.00000000000000000000 | 0.00001257097386458910 | −0.00001647650240267330 |
| A8 | 0.00000346655207640694 | 0.00001023044320286440 | −0.00001284349015055980 | −0.00002793540187686820 |
| A9 | 0.00000000000000000000 | 0.00000000000000000000 | −0.00000048808532490981 | −0.00000022061354071493 |
| A10 | 0.00000072895286581114 | 0.00000039326239475030 | 0.00000195339320795466 | 0.00000072592575431308 |
| A11 | 0.00000000000000000000 | 0.00000000000000000000 | −0.00000016114070599575 | 0.00000000000000000000 |
| A12 | 0.00000000000000000000 | 0.00000000000000000000 | 0.00000000000000000000 | 0.00000000000000000000 |
| A13 | 0.00000000000000000000 | 0.00000000000000000000 | 0.00000000000000000000 | 0.00000000000000000000 |
| A14 | 0.00000000000000000000 | 0.00000000000000000000 | 0.00000000000000000000 | 0.00000000000000000000 |
| A15 | 0.00000000000000000000 | 0.00000000000000000000 | 0.00000000000000000000 | 0.00000000000000000000 |
| A16 | 0.00000000000000000000 | 0.00000000000000000000 | 0.00000000000000000000 | 0.00000000000000000000 |
| A17 | 0.00000000000000000000 | 0.00000000000000000000 | 0.00000000000000000000 | 0.00000000000000000000 |
| A18 | 0.00000000000000000000 | 0.00000000000000000000 | 0.00000000000000000000 | 0.00000000000000000000 |
| A19 | 0.00000000000000000000 | 0.00000000000000000000 | 0.00000000000000000000 | 0.00000000000000000000 |
| A20 | 0.00000000000000000000 | 0.00000000000000000000 | 0.00000000000000000000 | 0.00000000000000000000 |

| Si | 16(1ST SURFACE OF L7) | 17(2ND SURFACE OF L7) |
|---|---|---|
| Ri | −46.56922510224970000000 | 24.17665392353390000000 |
| K | 0.00000000000000000000 | 0.00000000000000000000 |
| A3 | 0.00000000000000000000 | 0.00000000000000000000 |
| A4 | −0.00488292364619163000 | −0.00254581541165135000 |
| A5 | 0.00000000000000000000 | 0.00000000000000000000 |
| A6 | 0.00020737722037948900 | 0.00013931910637326900 |
| A7 | 0.00000000000000000000 | 0.00000000000000000000 |
| A8 | −0.00000356775941460936 | 0.00000161157371776014 |
| A9 | 0.00000000000000000000 | 0.00000000000000000000 |
| A10 | 0.00000000000000000000 | 0.00000000000000000000 |
| A11 | 0.00000000000000000000 | 0.00000000000000000000 |
| A12 | 0.00000000000000000000 | 0.00000000000000000000 |
| A13 | 0.00000000000000000000 | 0.00000000000000000000 |
| A14 | 0.00000000000000000000 | 0.00000000000000000000 |
| A15 | 0.00000000000000000000 | 0.00000000000000000000 |
| A16 | 0.00000000000000000000 | 0.00000000000000000000 |
| A17 | 0.00000000000000000000 | 0.00000000000000000000 |
| A18 | 0.00000000000000000000 | 0.00000000000000000000 |
| A19 | 0.00000000000000000000 | 0.00000000000000000000 |
| A20 | 0.00000000000000000000 | 0.00000000000000000000 |

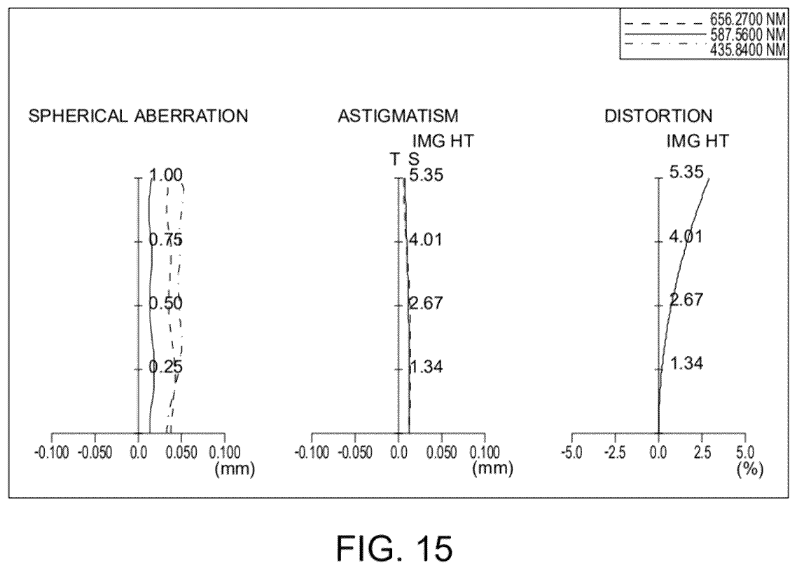

Aberrations in the fifth example are shown in FIG. 15. According to the imaging lens assembly 21 of the fifth example, by making the lens configuration and the lens parameters different from those of the first example, the degree of freedom in designing the camera module 11 may be further increased while obtaining the same effects as in the first example.

In the description of embodiments of the present disclosure, it is to be understood that terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” should be construed to refer to the orientation or the position as described or as shown in the drawings under discussion. These relative terms are only used to simplify description of the present disclosure, and do not indicate or imply that the device or element referred to must have a particular orientation, or constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Reference throughout this specification to “an embodiment”, “some embodiments”, “an exemplary embodiment”, “an example”, “a specific example” or “some examples” means that a particular feature, structure, material, or characteristic described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

1. An imaging lens assembly, comprising:
a prism that bends a light incident from an object side and emits the light to an image side; and
at least one lens disposed on the image side of the prism,
wherein the imaging lens assembly is configured such that:
$$5. \leq Σ d / Yh \leq 12.0 ,$$
where Σd is a distance on an optical axis from an optical surface closest to an object to an imaging surface, and Yh is an image height.

2. The imaging lens assembly according to claim 1,
wherein the prism being formed of resin material, and
wherein the imaging lens assembly is configured such that:
$$- 1. < ( ( PNd - 1.75 ) * PNd * 100 / PVd \leq - 0.56 ,$$
where PNd is a refractive index of the prism and PVd is an Abbe number of the prism.

3. The imaging lens assembly according to claim 1, configured such that:
$$Σ d / f \leq 4. ,$$
where Σd is a distance on an optical axis from an optical surface closest to an object to an imaging surface, and f is a focal length of the imaging lens assembly.

4. The imaging lens assembly according to claim 1,
wherein the prism further comprises a reflective film disposed on a reflective surface of the prism, and
wherein the imaging lens assembly is configured such that:
$$( 45 - ( ( 180 / π ) * ( {sin}^{- 1} ( ( {sin ( π / 180 )}^{*} θ ) / PNd ) ) / ( {sin}^{- 1} ( 1 / PNd ) * ( 180 / π ) < 1 ,$$
where PNd is a refractive index of the prism and θ is a half angle of view.

5. The imaging lens assembly according to claim 1, configured such that:
$$( 45 - ( ( 180 / π ) * ( {sin}^{- 1} ( ( {sin ( π / 180 )}^{*} θ ) / PNd ) ) / ( {sin}^{- 1} ( 1 / PNd ) * ( 180 / π ) < 1 ,$$
where PNd is a refractive index of the prism and θ is a half angle of view.

6. The imaging lens assembly according to claim 1, configured such that:
$$Pd / Yh > 1.3 ,$$
where Pd is a distance on an optical axis from an incident surface of the prism to an emitting surface of the prism, and Yh is an image height.

7. The imaging lens assembly according to claim 1, wherein a lens closest to an image has a negative refractive power.

8. The imaging lens assembly according to claim 1, wherein an optical image stabilizer is provided on the prism.

9. The imaging lens assembly according to claim 1, further comprising a second prism disposed on the image side of the at least one lens, the second prism bending a light incident from the lens side and emitting the light toward the image side.

10. The imaging lens assembly according to claim 1, further comprising at least one lens disposed on the object side of the prism.

11. The imaging lens assembly according to claim 1, wherein at least one of an incident surface or an emitting surface of the prism is a flat surface or a curved surface.

12. The imaging lens assembly according to claim 11, wherein the incident surface of the prism is a convex surface or a concave surface facing the object side; and/or
the emitting surface of the prism is a convex surface or a concave surface facing the image side.

13. The imaging lens assembly according to claim 1, wherein the at least one lens disposed on the image side of the prism comprises:
a first lens group having at least one lens; and
a second lens group disposed on the image side of the first lens group, the second lens group comprising at least one lens and being configured to be movable in an optical axis direction.

14. The imaging lens assembly according to claim 1, wherein the imaging lens assembly comprises an aspheric surface, the aspheric surface is defined by:
$$Z = C \times {h}^{2} / \{ 1 + {( 1 - K \times {C}^{2} \times {h}^{2} )}^{1 / 2} \} + Σ An \times {h}^{n} ,$$
wherein Z is a depth of the aspheric surface, C is a paraxial curvature which is equal to 1/R, h is a distance from the optical axis to a lens surface, K is a conic constant, An is an nth-order aspheric coefficient, and n is an integer greater than or equal to 3.

15. A camera module, comprising:
an imaging lens assembly, comprising:
a prism that bends a light incident from an object side and emits the light to an image side; and
at least one lens disposed on the image side of the prism,
wherein the imaging lens assembly is configured such that:
$$5. 0 \leq Σ d / Yh \leq 12.0 ,$$
where Σd is a distance on an optical axis from an optical surface closest to an object to an imaging surface, and Yh is an image height; and
an image sensor having an imaging surface.

16. The camera module according to claim 15,
wherein the prism being formed of resin material, and
wherein the imaging lens assembly is configured such that:
$$- 1. < ( ( PNd - 1.75 ) * PNd * 100 / PVd \leq - 0.56 ,$$
where PNd is a refractive index of the prism and PVd is an Abbe number of the prism.

17. The camera module according to claim 15, configured, in both a wide side and a telephoto side, such that:
$$Σ d / f \leq 4. ,$$
where Σd is a distance on an optical axis from an optical surface closest to an object to an imaging surface, and f is a focal length of the imaging lens assembly.

18. The camera module according to claim 15, wherein a lens closest to an image has a negative refractive power.

19. An imaging device, comprising:
a camera module, comprising:
an imaging lens assembly, comprising:
a prism that bends a light incident from an object side and emits the light to an image side; and
at least one lens disposed on the image side of the prism,
wherein the imaging lens assembly is configured such that:
$$5. \leq Σ d / Yh \leq 12.0 ,$$
where Σd is a distance on an optical axis from an optical surface closest to an object to an imaging surface, and Yh is an image height; and
an image sensor having an imaging surface; and
a housing that stores the camera module.

20. The imaging device according to claim 19, further comprising:
at least one lens driver that drives the at least one lens in an optical axis direction; and
an optical image stabilizer provided on the prism.
